(19) United States
(12) Patent Application Publication
(10) Pub. No.: US 2013/0238804 A1
(43) Pub. Date: Sep. 12, 2013

(54) COMPUTER SYSTEM, MIGRATION METHOD, AND MANAGEMENT SERVER

(71) Applicants: Mitsuhiro Tanino, Tokyo (JP); Tomohito Uchida, Yokohama (JP)

(72) Inventors: Mitsuhiro Tanino, Tokyo (JP); Tomohito Uchida, Yokohama (JP)

(73) Assignee: HITACHI, LTD., Tokyo (JP)

(21) Appl. No.: 13/879,035

(22) PCT Filed: Nov. 16, 2010
(86) PCT No.: PCT/JP2010/070387

§ 371 Date: May 29, 2013

(51) Int. Cl. G06F 9/48

(52) U.S. Cl. CPC G06F 9/4856
USPC 709/226

(57) ABSTRACT

A computer system, comprising: a plurality of physical computers; and a management server for managing the plurality of physical computers, wherein at least one virtual computer operates on each of the plurality of physical computers, wherein the at least one virtual computer executes at least one piece of service processing including at least one piece of sub processing, wherein the management server is configured to calculate a required resource amount which is a resource amount of a computer resource required for the virtual computer subject to the migration based on used resource amount for the each of the plurality of the pieces of sub processing; search for a physical computer of a migration destination; and migrate the virtual computer subject to the migration to the physical computer of the migration destination.

### BACKGROUND OF THE INVENTION

This invention relates to a migration technology for migrating a virtual server operating on a physical server in a cloud environment.

In the cloud environment, servers having different performances are mixed. For example, a server has a CPU high in clock frequency and a server has a CPU low in clock frequency are mixed. In a resource pool, a total value (total value of clock frequencies in the case of CPUs) of resource amounts included in the respective server devices included in the resource pool is managed as a resource amount of the resource pool.

For example, a resource pool including four CPUs each being a clock frequency of 3 GHz, and a resource pool including six CPUs each being a clock frequency of 2 GHz both have a total value of the clock frequencies of 12 GHz, and are thus treated as resource pools having the same CPU resources.

A user uses a virtual server device (VM) constructed by using the server device, thereby providing a service. In a case where a failure occurs, the user can continue to provide the service by migrating the virtual server device to another server device.

As the migration method, for example, there is a method of finding, in a datacenter, a datacenter of migration destination based on a network condition, a server requirement, and a storage requirement required by an application (for example, refer to Japanese Patent Application Laid-open No. 2009-134687).

In the cloud environment, in a case where the virtual server device is migrated to a server device included in a resource pool, a resource pool of the migration destination is determined based on a resource amount assigned to the virtual server device.

Specifically, a resource pool provided with a resource amount equal to or more than the resource amount assigned to the virtual server device is determined as the resource pool of migration destination.

### SUMMARY OF THE INVENTION

However, in the conventional method, in such a case where a used resource amount of the virtual server device is small, even if a resource pool includes a resource amount equal to or more than the used resource amount, the resource pool is not selected as the migration destination. In other words, a resource pool having a resource amount equal to or more than a resource amount required for the virtual server device may be selected. As a result, an effective use of the resources is difficult.

This invention has an object to realize the effective use of computer resources in a cloud environment by searching for a resource pool of migration destination based on a resource amount required for a virtual server device.

The present invention can be appreciated by the description which follows in conjunction with the following figures, wherein: a computer system, comprising: a plurality of physical computers; and a management server for managing the plurality of physical computers. Wherein at least one virtual computer operates on each of the plurality of physical computers, which is assigned an assigned resource generated by dividing a computer resource included in the each of the plurality of physical computers into a plurality of parts. Wherein the at least one virtual computer executes at least one piece of service processing including at least one piece of sub processing. Wherein the each of the plurality of physical computers includes: a first processor; a first main storage medium coupled to the first processor; a sub storage medium coupled to the first processor; a first network interface coupled to the first processor; a virtual management module for managing the at least one virtual computer; and a used resource amount obtaining module for obtaining a used resource amount which is information on a used amount of the assigned resource used by executing the at least one piece of service processing. Wherein the management server includes: a second processor; a second storage medium coupled to the second processor; a second network interface coupled to the second processor; a resource information management module for managing resource information including information on the computer resource included in the each of the plurality of physical computers; an assigned resource information management module for managing assigned resource information including information on the assigned resource; an obtaining command module for transmitting a command to obtain the used resource amount to the virtual management module; and a migration processing module for executing migration processing for a virtual computer. Wherein the management server is configured to transmit the obtaining command to a plurality of the virtual computers. Wherein each of the plurality of the virtual computers is configured to: obtain the used resource amount for each of a plurality of the pieces of sub processing based on the received obtaining command; and transmit the obtained used resource amount for the each of the plurality of the pieces of sub processing to the management server.

Wherein the management server is configured to: obtain the resource information and the assigned resource information from the each of the plurality of physical computers; generate free resource information which is information on a free resource representing an unused computer resource in the computer system based on the obtained resource information and the obtained assigned resource information, in a case where the management server receives a request to execute the migration processing of the virtual computer; calculate a required resource amount which is a resource amount of a computer resource required for the virtual computer subject to the migration based on the obtained used resource amount for the each of the plurality of the pieces of sub processing; search for a physical computer of a migration destination based on the generated free resource information and the calculated required resource amount; and migrate the virtual computer subject to the migration to the physical computer of the migration destination based on a result of the search.

According to this invention, the physical computer of migration destination is searched for based on the used resource amount of the sub processing, and hence, compared with the search based on the assigned resource assigned to the virtual computer, the virtual computer can be migrated to a physical computer having a more appropriate resource amount. Thus, the resources in the computer system can be efficiently used.

### BRIEF DESCRIPTION OF THE DRAWINGS

The present invention can be appreciated by the description which follows in conjunction with the following figures, wherein:

FIG. 1 is an explanatory diagram illustrating a configuration example of a computer system according to the first embodiment of this invention;

FIG. 2 is an explanatory diagram illustrating an example of a hardware configuration and a software configuration of a management server according to the first embodiment of this invention;

FIG. 3 is an explanatory diagram illustrating an example of a hardware configuration and a software configuration of a physical server according to the first embodiment of this invention;

FIG. 4 is an explanatory diagram illustrating an example of a hardware configuration of a storage system according to the first embodiment of this invention;

FIG. 5 is an explanatory diagram illustrating a logical configuration of the computer system according to the first embodiment of this invention;

FIG. 6 is an explanatory diagram illustrating an example of process management information according to the first embodiment of this invention;

FIG. 7 is an explanatory diagram illustrating an example of user-defined information according to the first embodiment of this invention;

FIG. 8 is an explanatory diagram illustrating an example of physical server management information according to the first embodiment of this invention;

FIG. 9 is an explanatory diagram illustrating an example of virtual server management information according to the first embodiment of this invention;

FIG. 10 is an explanatory diagram illustrating an example of process performance index information according to the first embodiment of this invention;

FIG. 11 is an explanatory diagram illustrating an example of free resource pool management information according to the first embodiment of this invention;

FIG. 12 is a flowchart illustrating processing executed by a physical server configuration management module according to the first embodiment of this invention;

FIG. 13 is a flowchart illustrating processing executed by a virtual server configuration management module according to the first embodiment of this invention;

FIG. 14 is a flowchart illustrating processing executed by processor performance management module according to the first embodiment of this invention;

FIG. 15 is a flowchart illustrating processing executed by a workload management module according to the first embodiment of this invention;

FIG. 16 is a flowchart illustrating processing executed by a physical server configuration obtaining module according to the first embodiment of this invention;

FIG. 17 is a flowchart illustrating processing executed by a virtual server configuration obtaining module according to the first embodiment of this invention;

FIG. 18 is a flowchart illustrating processing executed by a processor performance obtaining module according to the first embodiment of this invention;

FIG. 19 is a flowchart illustrating processing executed by a process information obtaining module according to the first embodiment of this invention;

FIG. 20 is a flowchart illustrating processing executed by a VM migration control module according to the first embodiment of this invention

FIG. 21 is a flowchart illustrating details of resource calculation processing according to the first embodiment of this invention;

FIG. 22 is a flowchart illustrating details of search processing according to the first embodiment of this invention;

FIGS. 23A and 23B are explanatory diagrams illustrating application examples of the first embodiment of this invention;

FIG. 24 is an explanatory diagram illustrating a logical configuration of the computer system according to the second embodiment of this invention;

FIG. 25 is an explanatory diagram illustrating an example of the process management information according to the second embodiment of this invention;

FIG. 26 is an explanatory diagram illustrating an example of the virtual server management information according to the second embodiment of this invention; and

FIG. 27 is an explanatory diagram illustrating an example of the free resource pool management information according to the second embodiment of this invention.

### DETAILED DESCRIPTION OF THE PREFERRED EMBODIMENTS

A description is now given of embodiments of this invention referring to the drawings. It should be noted that like components are denoted by like numerals.

As virtualization methods, there are a VM method and an LPAR method.

The VM method is a method of time-dividing, by a virtualization management module such as a hypervisor, computer resources of a physical server to assign the time-divided computer resources to virtual servers. The LPAR method is a method of assigning, by a virtualization management module, a virtual server to an LPAR, which includes logically divided computer resources of a physical server.

A description is now given respectively of embodiments for the VM method and the LPAR method.

### First Embodiment

In a first embodiment, a description is given of a virtualization technology by means of the VM method.

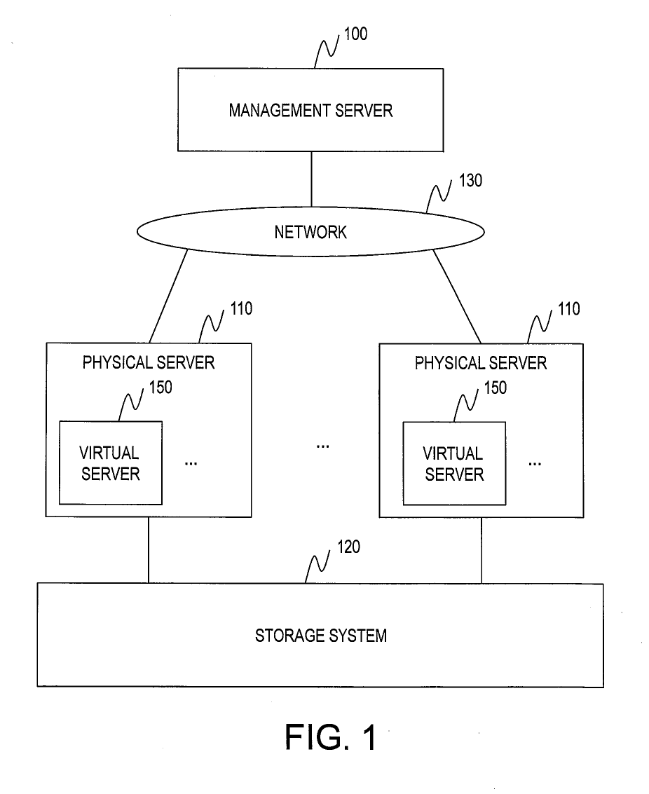

FIG. 1 is an explanatory diagram illustrating a configuration example of a computer system according to the first embodiment of this invention.

The computer system includes a management server 100, physical servers 110, and a storage system 120.

The management server 100 and the physical servers 110 are coupled to each other via a network 130. As the network 130, for example, a LAN, a WAN, or the like is conceivable.

Moreover, the physical servers 110 and the storage system 120 are coupled to each other directly or via a SAN or the like.

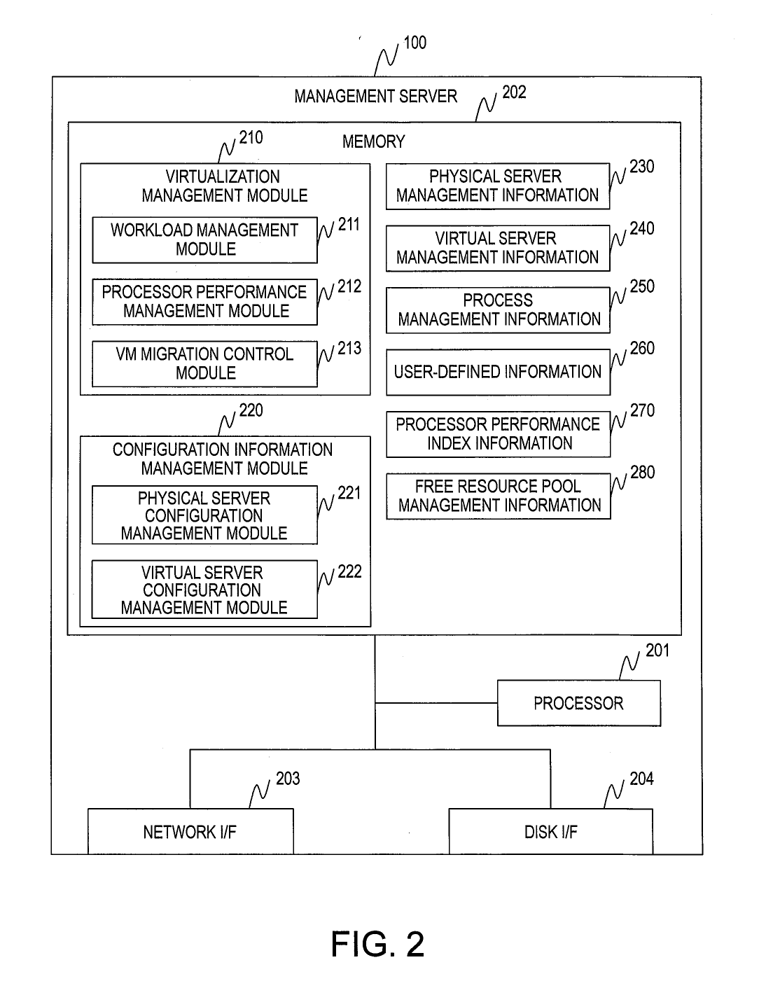

The management server 100 manages the entire computer system. A hardware configuration and a software configuration of the management server 100 are described later with reference to FIG. 2.

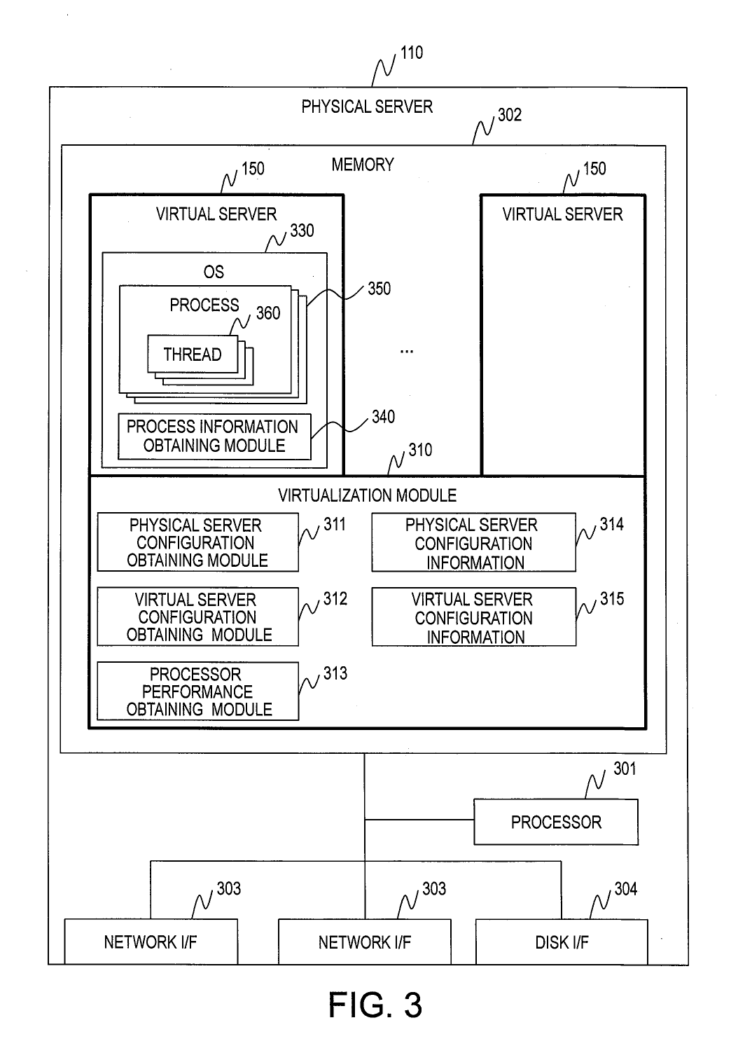

The physical server 110 is a computer on which virtual servers 150 operate so that a user provides a service. A hardware configuration and a software configuration of the physical server 110 are described later with reference to FIG. 3.

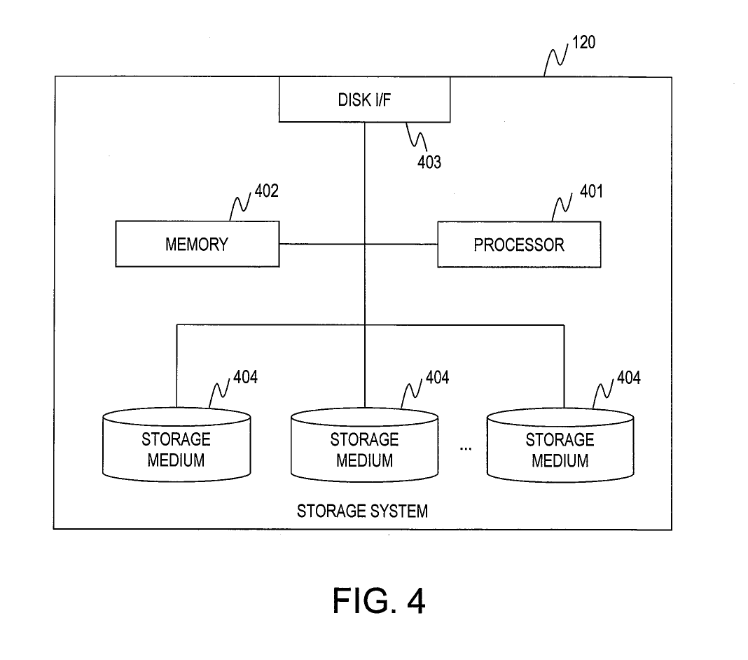

The storage system 120 provides a storage area to be assigned to virtual servers 150. A hardware configuration and a software configuration of the storage system 120 are described later with reference to FIG. 4.

FIG. 2 is an explanatory diagram illustrating an example of the hardware configuration and the software configuration of the management server 100 according to the first embodiment of this invention.

The management server 100 includes, as the hardware configuration, a processor 201, a memory 202, a network I/F 203, and a disk I/F 204. It should be noted that the management server 100 may have other hardware configuration such as an HDD.

The processor 201 includes a plurality of processor cores (not shown) for executing arithmetic operations, and executes programs stored in the memory 202. As a result, functions included in the management server 100 are realized.

The memory 202 stores the programs executed by the processor 201, and information required to execute the programs.

The network I/F 203 is an interface for coupling to the network 130. The disk I/F 204 is an interface for coupling to an external storage system (not shown).

A description is now given of the software configuration of the management server 100.

The memory 202 stores programs for realizing a virtualization management module 210 and a configuration information management module 220, and physical server management information 230, virtual server management information 240, process management information 250, user-defined information 260, processor performance index information 270, and free resource pool management information 280.

The virtualization management module 210 manages information held by a virtualization module 310 (refer to FIG. 3) operating on the physical server 110. The virtualization management module 210 includes a workload management module 211, a processor performance management module 212, and a VM migration control module 213.

The workload management module 211 manages information on processing (such as processes and threads) executed on the virtual server 150. Specifically, the workload management module 211 obtains information such as a usage rate of a computer resource used by the processing (such as a process or a thread) executed on the virtual server 150. Moreover, the workload management module 211 stores the obtained information in the process management information 250.

The processor performance management module 212 obtains performance information on a processor 301 included in the physical server 110 (refer to FIG. 3), and stores the obtained performance information in the processor performance index information 270.

The VM migration control module 213 executes migration processing for migrating the virtual server 150 to another physical server 110.

The configuration information management module 220 manages configuration information on the physical servers 110 and the virtual servers 150. The configuration information management module 220 includes a physical server configuration management module 221 and a virtual server configuration management module 222.

The physical server configuration management module 221 manages the configuration information on the physical servers 110. Specifically, the physical server configuration management module 221 obtains, from each of the physical servers 110, the configuration information on the physical server 110, and stores the obtained configuration information in the physical server configuration information 230.

According to this embodiment, computer resources included in one physical server 110 are managed as one resource pool. It should be noted that this invention is not limited to this configuration, and, for example, computer resources included in a plurality of physical servers 110 may be managed as one resource pool.

The virtual server configuration management module 222 manages information on computer resources (such as processor and memory) assigned to the virtual servers 150, namely, configuration information on the virtual servers 150. Specifically, the virtual server configuration management module 222 obtains, from the virtualization module 310 (refer to FIG. 3), the configuration information on the virtual servers 150 operating on the virtualization module 310 (refer to FIG. 3), and stores the obtained configuration information on the virtual servers 150 in the virtual server management information 240.

The physical server management information 230 stores the configuration information on the physical servers 110. Details of the physical server management information 230 are described later with reference to FIG. 8.

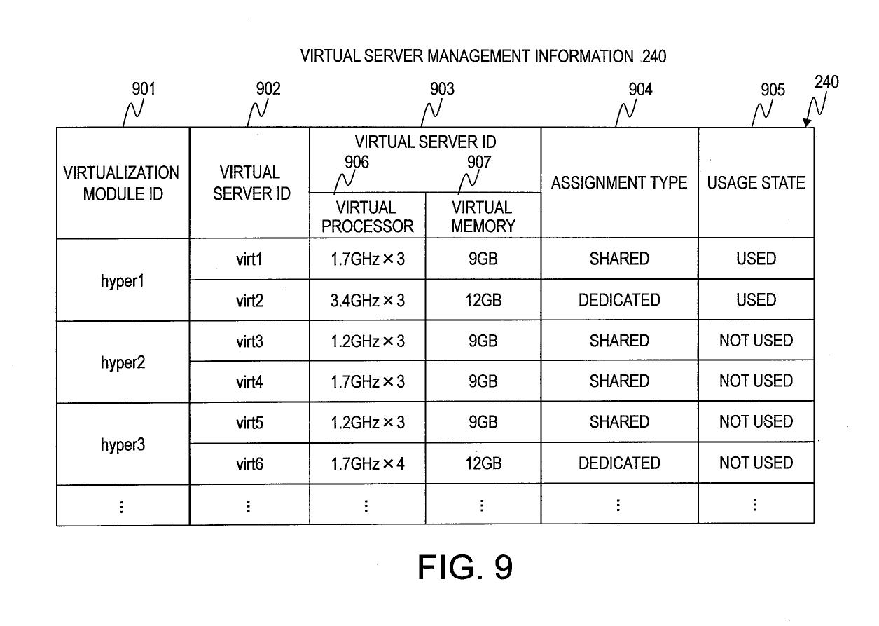

The virtual server management information 240 stores the configuration information on the virtual servers 150. Details of the virtual server management information 240 are described later with reference to FIG. 9.

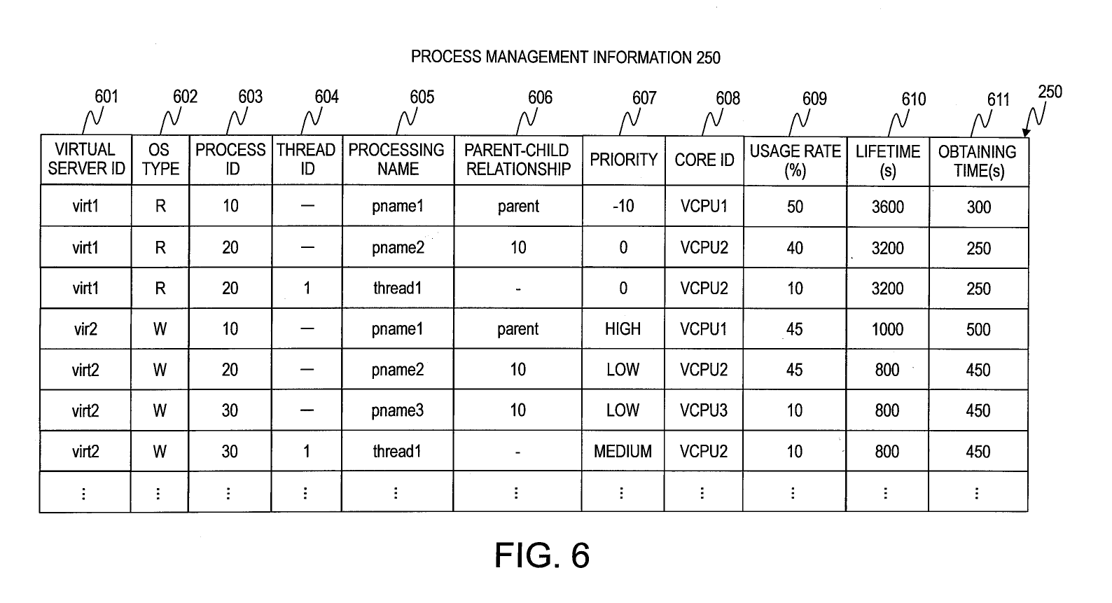

The process management information 250 stores the information on processing (such as processes and threads) executed on the virtual servers 150. Details of the process management information 250 are described later with reference to FIG. 6.

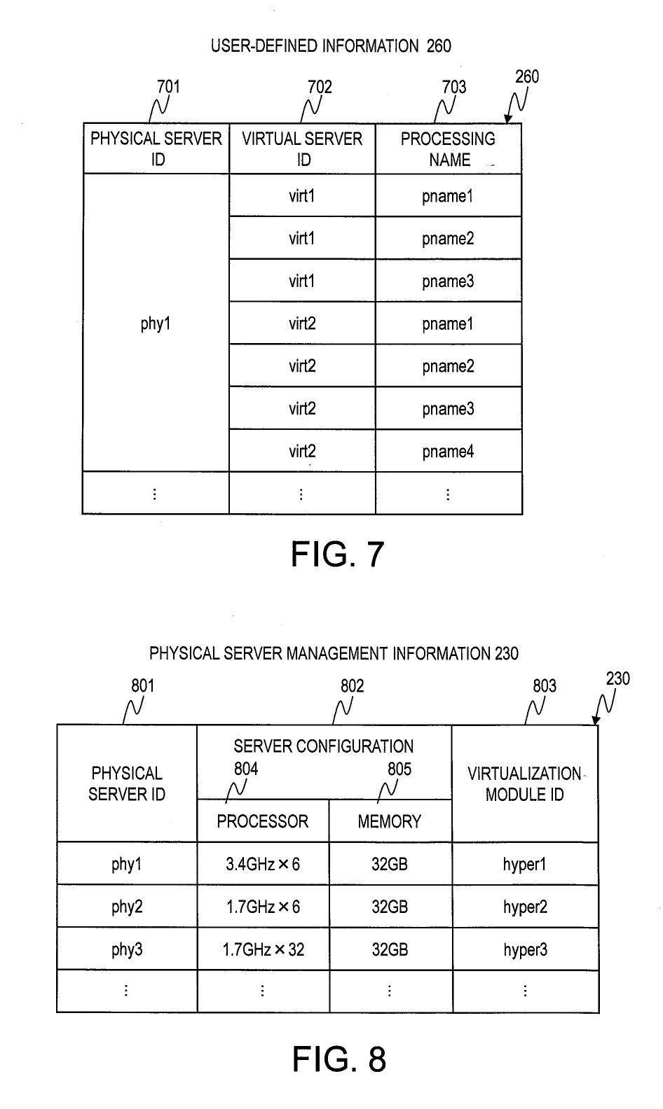

The user-defined information 260 stores information on processing (such as processes and threads) specified by the user out of the processing (such as processes and threads) executed on the virtual servers 150. Details of the user-defined information 260 are described later with reference to FIG. 7. The user-defined information 260 is information input by the user in a case where migration of the virtual server 150 is executed.

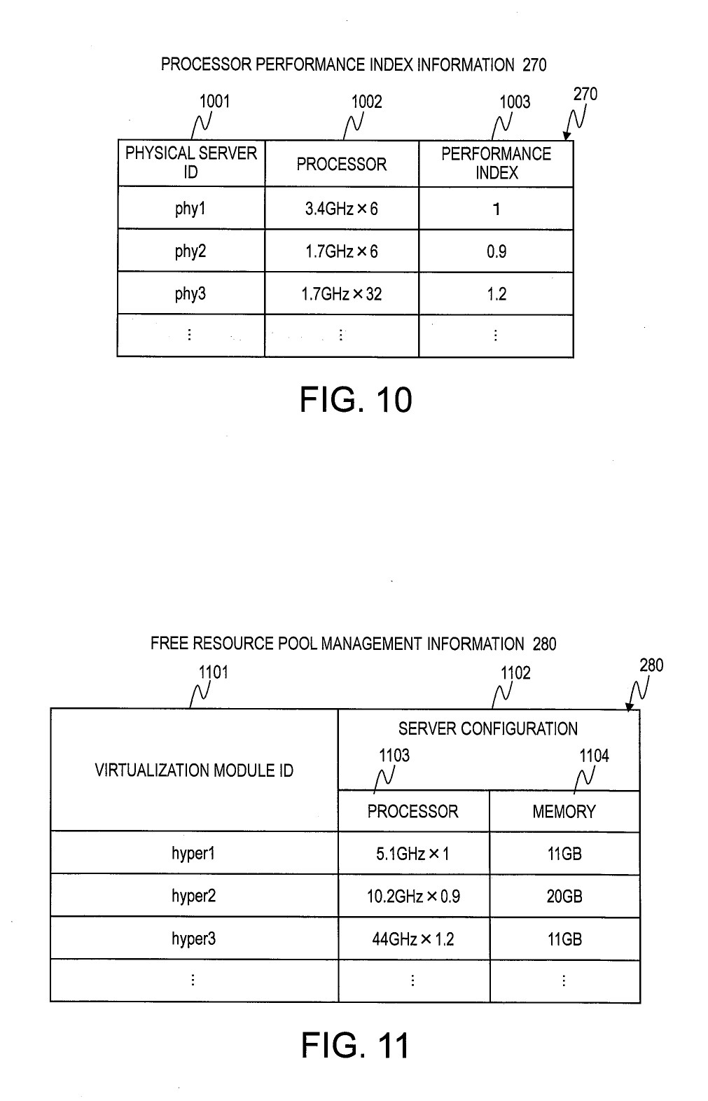

The processor performance index information 270 stores performance information on the processors included in the physical servers 110. Details of the processor performance index information 270 are described later with reference to FIG. 10.

The free resource pool management information 280 stores information on unused computer resources, namely, free resource pools. According to this embodiment, based on the physical server management information 230, the virtual server management information 240, and the processor performance index information 270, the free resource pool management information 280 is generated.

It should be noted that, details of the free resource pool management information 280 are described later with reference to FIG. 11.

According to this embodiment, unused computer resources out of the computer resources included in one physical server 110 are managed as one free resource pool. It should be noted that this invention is not limited to this configuration, and, for example, unused computer resources in a plurality of physical servers 110 may be managed as one free resource pool.

According to this embodiment, though the virtualization management module 210, the configuration information management module 220, the workload management module 211, the processor performance management module 212, the VM migration control module 213, the physical server configuration management module 221, and the virtual server configuration management module 222 are realized by means of software, these components may be realized by means of hardware.

FIG. 3 is an explanatory diagram illustrating an example of the hardware configuration and the software configuration of the physical server 110 according to the first embodiment of this invention.

The physical server 110 includes the processor 301, a memory 302, network I/Fs 303, and a disk I/F 304.

The processor 301 includes a plurality of processor cores (not shown) for executing arithmetic operations, and executes programs stored in the memory 302. As a result, functions included in the physical server 110 are realized.

The memory 302 stores the programs executed by the processor 301, and information required to execute the programs.

The network I/Fs 303 are each an interface for coupling to the network 130.

The disk I/F 304 is an interface for coupling to the storage system 120.

A description is now given of the software configuration of the physical server 110.

The memory 302 stores a program for realizing the virtualization management module 310.

The virtualization module 310 generates a plurality of virtual servers 150 by dividing the computer resources included in the physical server 110. Moreover, the virtualization module 310 manages the generated virtual severs 150. The virtualization module 310 according to this embodiment realizes a virtual environment by means of the VM method.

The virtualization module 310 includes a physical server configuration obtaining module 311, a virtual server configuration obtaining module 312, a processor performance obtaining module 313, physical server configuration information 314, and virtual server configuration information 315.

The physical server configuration obtaining module 311 reads, in a case of receiving a request to obtain the configuration information on the physical server 110 from the management server 100, the configuration information on the physical server 110 from the physical server configuration information 314, and transmits the read configuration information on the physical server 110 to the management server 100.

It should be noted that the physical server configuration obtaining module 311 may directly obtain the information from the physical server 110 in a case of receiving the request to obtain the configuration information on the physical server 110.

The virtual server configuration obtaining module 312 reads, in a case of receiving a request to obtain the configuration information on the virtual server 150 from the management server 100, the configuration information on the virtual server 150 from the virtual server configuration information 315, and transmits the read configuration information on the virtual server 150 to the management server 100.

It should be noted that the virtual server configuration obtaining module 312 may directly obtain the information from the virtual server 150 in a case of receiving the request to obtain the configuration information on the virtual server 150.

The processor performance obtaining module 313 obtains, in a case of receiving a request to obtain performance information on the processor 301 from the management server 100, the performance information on the processor 301, and transmits the obtained performance information to the management server 100.

The physical server configuration information 314 stores information on the software configuration and the hardware configuration on the physical server 110.

The virtual server configuration information 315 stores information on computer resources assigned to the virtual servers 150.

The virtual server 150 operates as one computer. The virtual server 150 executes an OS 330. Further, on the OS 330, one or more applications (not shown) are executed. The application (not shown) includes one or more processes 350. Moreover, the process 350 includes a plurality of threads 360.

It should be noted that this invention is not limited to an inclusion relationship between the process 350 and the threads 360 illustrated in FIG. 3. In other words, the process 350 or the thread 360 may be differently treated.

The OS 330 includes a process information obtaining module 340. The process information obtaining module 340 obtains information on computer resources used by applications executed on the OS 330.

According to this embodiment, for each process 350 or each thread 360 as a unit, used amounts of the computer resources are obtained.

The information obtained by the process information obtaining module 340 is transmitted from the virtualization module 310 to the management server 100.

According to this embodiment, though the virtualization module 310, the physical server configuration obtaining module 311, the virtual server configuration obtaining module 312, the processor performance obtaining module 313, the physical server configuration information 314, and the virtual server configuration information 315 are realized by means of software, these components may be realized by means of hardware.

FIG. 4 is an explanatory diagram illustrating an example of the hardware configuration of the storage system 120 according to the first embodiment of this invention.

The storage system 120 has a processor 401, a memory 402, a disk I/F 403, and storage media 404.

The processor 401 includes a plurality of processor cores (not shown), and executes programs stored in the memory 402. As a result, functions included in the storage system 120 are realized.

The memory 402 stores the programs executed by the processor 401, and information required to execute the programs.

The disk I/F 103 is an interface for coupling to the storage media 404.

The storage media 404 each store various types of information. As the storage media 404, an HDD, an SSD, a nonvolatile memory, and the like are conceivable.

It should be noted that the storage system 120 may constitute a disk array from a plurality of storage media 404, thereby managing the storage media as a single storage area.

Moreover, the storage system 120 may generate a plurality of LUs by logically dividing the storage area of the storage media 404 or the disk array, and may assign the generated LUs to the respective virtual servers 150.

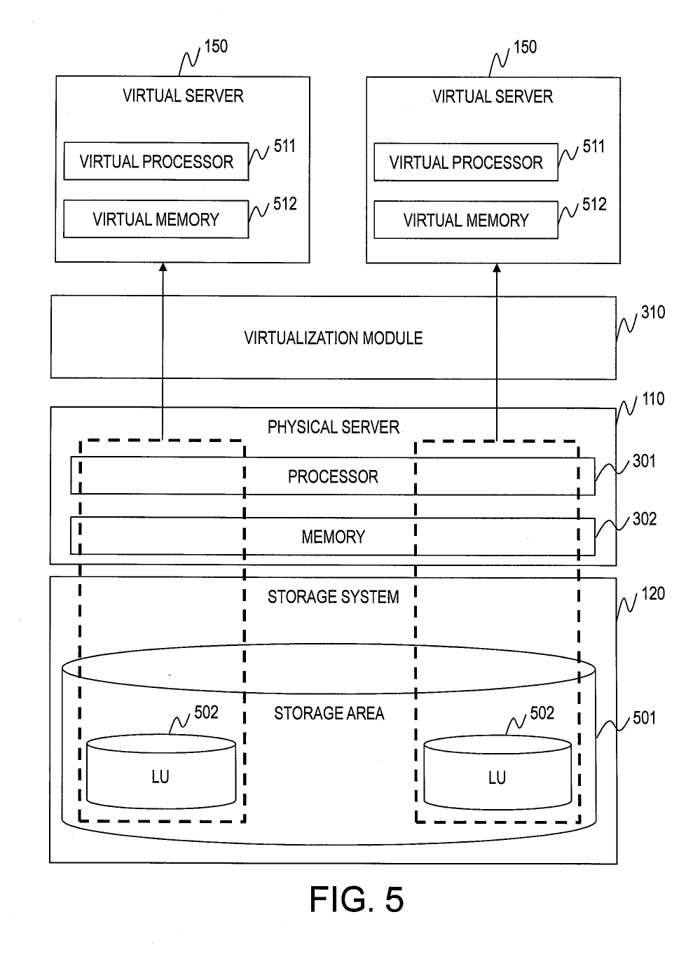

FIG. 5 is an explanatory diagram illustrating a logical configuration of the computer system according to the first embodiment of this invention.

The virtualization module 310 time-divides the computer resources such as the processor 301 and the memory 302 included in the physical server 110, thereby assigning the divided computer resources to the virtual servers 150. The virtual server 150 recognizes the assigned computer resources as a virtual processor 511 and a virtual memory 512.

The storage system 120 assigns LUs 502 generated by logically dividing a storage area 501 to the respective virtual servers 150. In the LU 502, executable images of the OS 330 and the like are stored.

The computer resource may also be hereinafter simply referred to as resource.

FIG. 6 is an explanatory diagram illustrating an example of the process management information 250 according to the first embodiment of this invention.

The process management information 250 includes virtual server IDs 601, OS types 602, process IDs 603, thread IDs 604, processing names 605, parent-child relationships 606, priorities 607, core IDs 608, usage rates 609, lifetimes 610, and obtaining times 611.

The virtual server ID 601 stores an identifier for uniquely identifying a virtual server 150.

The OS type 602 stores a type of the OS 330 executed by the virtual server 150 corresponding to the virtual server ID 601.

Definitions of the process 350, the thread 360, and the like vary depending on the type of the OS 330, and pieces information stored in the process ID 603, the thread ID 604, the parent-child relationship 606, and the priority 607 are thus vary depending on the type of the OS 330.

According to this embodiment, based on the OS type 602, definitions of the process 350, the thread 360, and the like are identified.

The process ID 603 stores an identifier for uniquely identifying a process 350 executed on the virtual server 150 corresponding to the virtual server ID 601. For the same process 350, the same process ID 603 is stored.

The thread ID 604 stores an identifier for uniquely identifying a thread 360 generated by the process 350 corresponding to the process ID 603. If an identifier is stored in the thread ID 604, this represents that the processing is based on a thread 360.

The processing name 605 stores a name of the process 350 or the thread 360 corresponding to the process ID 603 or the thread ID 604.

The parent-child relationship 606 stores a parent-child relationship of the process 350. If “parent” is stored in the parent-child relationship 606, this case represents that the entry is a parent process. In the parent-child relationship 606 of a child process 350 generated from a parent process 350, the process ID 603 of the parent process 350 is stored.

The priority 607 stores information on importance of the process 350 or the thread 360 executed on the virtual server 150 corresponding to the virtual server ID 601. It should be noted that the information stored in the priority 607 varies depending on the OS type 602. For example, a numerical value or information such as “high, medium, or low” is stored.

The core ID 608 stores an identifier of a virtual processor core included in a virtual processor 511 assigned to the virtual server 150 corresponding to the virtual server ID 601.

The usage rate 609 stores a usage rate of the virtual processor 511 corresponding to the core ID 608.

The lifetime 610 stores a lifetime of the process 350 corresponding to the process ID 603 or the thread 360 corresponding to the thread ID 604.

The obtaining time 611 stores an obtaining time of information on the process 350 corresponding to the process ID 603 or the thread 360 corresponding to the thread ID 604.

FIG. 7 is an explanatory diagram illustrating an example of the user-defined information 260 according to the first embodiment of this invention.

The user-defined information 260 includes a physical server ID 701, a virtual server ID 702, and a processing name 703.

The physical server ID 701 stores an identifier for uniquely identifying a physical server 110.

The virtual server ID 702 stores an identifier for uniquely identifying a virtual server 150 on the physical server 110 corresponding to the physical server ID 701. The virtual server ID 702 is the same information as the virtual server ID 601.

The processing name 703 stores a name of a process 350 or a thread 360 executed on the virtual server 150 corresponding to the virtual server ID 702. The processing name 703 is the same information as the processing name 605.

FIG. 8 is an explanatory diagram illustrating an example of the physical server management information 230 according to the first embodiment of this invention.

The physical server management information 230 includes a physical server ID 801, a server configuration 802, and a virtualization module ID 803.

The physical server ID 801 stores an identifier for uniquely identifying a physical server 110. The physical server ID 801 stores the same information as the physical server ID 701.

The server configuration 802 stores information on resources included in the physical server 110 corresponding to the physical server ID 801. The server configuration 802 includes a processor 804 and a memory 805. It should be noted that the server configuration 802 may include other information.

The processor 804 stores a resource amount of a processor 301 included in the physical server 110 corresponding to the physical server ID 801. According to this embodiment, a product of the frequency of the processor 301 included in the physical server 110, and the number of processor cores included in the processor 301 is stored.

It should be noted that this invention is not limited to this value. A product of the frequency of the processor 301 and the number of sockets may be stored.

The memory 805 stores a resource amount of the memory 302 included in the physical server 110 corresponding to the physical server ID 801. According to this embodiment, a capacity of a total storage area of the memory 302 included in the physical server 110 is stored.

The virtualization module ID 803 stores an identifier for uniquely identifying the virtualization module 310 on the physical server 110 corresponding to the physical server ID 801.

FIG. 9 is an explanatory diagram illustrating an example of the virtual server management information 240 according to the first embodiment of this invention.

The virtual server management information 240 includes virtualization module IDs 901, virtual server IDs 902, virtual server configurations 903, assignment methods 904, and usage states 905.

The virtualization module ID 901 stores an identifier for uniquely identifying a virtualization module 310. The virtualization module ID 901 is the same information as the virtualization module ID 803.

The virtual server ID 902 stores an identifier for uniquely identifying a virtual server 150 managed by the virtualization module 310 corresponding to the virtualization module ID 901. The virtual server ID 902 is the same information as the virtual server ID 601.

The virtual server configuration 903 stores information on resources assigned to the virtual server 150 corresponding to the virtual server ID 902. The virtual server configuration 903 includes a virtual processor 906 and a virtual memory 907. It should be noted that the virtual server configuration 903 may include other information.

The virtual processor 906 stores a resource amount of a virtual processor 511 assigned to the virtual server 150. Specifically, a product of the frequency of processor cores included in the virtual processor 511 and the number of processor cores is stored.

FIG. 9 illustrates, for example, a case where, to a virtual server 150 having a virtualization module ID 901 of “hyper 1” and a virtual server ID 902 of “virt1”, a virtual processor 511 including three processor cores being a frequency of “1.7 GHz” is assigned.

It should be noted that this invention is not limited to this value. A product of the frequency of the virtual processor 511 and the number of sockets may be stored in the virtual processor 906.

The virtual memory 907 stores a resource amount of a virtual memory 512 assigned to the virtual server 150.

It should be noted that the virtualization module 310 assigns the processor 301 included in the physical server 110 to each of the virtual servers 150 so as to satisfy the resource amount stored in the virtual processor 906. Moreover, the virtualization module 310 assigns the memory 302 included in the physical server 110 to each of the virtual servers 150 so as to satisfy the resource amount stored in the virtual memory 907.

The assignment method 904 stores an assignment method for the processor 301.

Specifically, if the assignment method 904 is “shared”, the method represents a state where a part of the resource indicated in the virtual processor 906 can be assigned to another virtual server 150. Moreover, if the assignment method 904 is “dedicated”, the method represents a state where the resource indicated in the virtual processor 906 is always assigned.

The usage state 905 stores information on whether the virtual server 150 is operating or not. For example, if the OS 330 is being executed, “used” is stored in the usage state 905, and if the OS 330 is not being executed, “not used” is stored in the usage state 905.

FIG. 10 is an explanatory diagram illustrating an example of the process performance index information 270 according to the first embodiment of this invention.

The processor performance index information 270 includes physical server IDs 1001, processors 1002, and performance indices 1003.

The physical server ID 1001 stores an identifier for uniquely identifying a physical server 110. The physical server ID 1001 is the same information as the physical server ID 701.

The processor 1002 stores a resource amount of a processor 301 included in a physical server 110 corresponding to the physical server ID 1001. Specifically, a product of the frequency of processor cores included in the processor 301 and the number of processor cores is stored.

It should be noted that this invention is not limited to this value. A product of the frequency of the processor 301 and the number of sockets may be stored in the virtual processor 906.

The performance index 1003 stores information for evaluating a performance of the processor 301 included in the physical server 110 corresponding to the physical server ID 1001.

The processors 301 included in the physical servers 110 cannot be uniformly compared in performance with each other due to the clock frequency, the cache, the architecture, and the like, and hence, according to this embodiment, the performance index 1003 is used as an index for comparing the processors 301 with each other in performance. The performance index 1003 is obtained by controlling the processor 301 to execute the same benchmark. The benchmark to be executed may be any benchmark.

According to this embodiment, by using the performance index 1003, a resource amount required on a physical server 110 of migration destination is calculated.

FIG. 11 is an explanatory diagram illustrating an example of the free resource pool management information 280 according to the first embodiment of this invention.

The free resource pool management information 280 includes virtualization module IDs 1101 and server configurations 1102.

The virtualization module ID 1101 stores an identifier for uniquely identifying a virtualization module 310. The virtualization module ID 1101 is the same information as the virtualization module ID 803.

The server configuration 1102 stores information on free resource amounts of the physical server 110 on which the virtualization module 310 corresponding to the virtualization module ID 1101 is operating. The server configuration 1102 includes a processor 1103 and a memory 1104. It should be noted that the server configuration 1102 may include other information.

The processor 1103 stores an unused resource amount of the processor 301 in the physical server 110. According to this embodiment, a value calculated in the following way is stored.

(Processor 1103)=((Processor 804)−(Total value of virtual processors))×(Performance index 1003)

In this expression, “Total value of virtual processors” represents a total value of virtual processors 906 of all of the virtual servers 150 managed by the virtualization module 310 corresponding to the virtualization module ID 1101.

For example, if the virtualization module ID 1101 is “hyper 1”, the processor 1103 is calculated in the following way.

(Processor 1103)={3.4 GHz×6−(1.7 GHz×3+3.4 GHz×3)}×1=5.1 GHz×1

The memory 1104 stores an unused resource amount of the memory 302 in the physical server 110. According to this embodiment, a value calculated in the following way is stored.

(Memory 1104)=((Memory 805)−(Total value of virtual memories))

In this expression, “Total value of virtual memories” represents a total value of virtual memories 907 of all of the virtual servers 150 managed by the virtualization module 310 corresponding to the virtualization module ID 1101.

For example, if the virtualization module ID 1101 is “hyper1”, the memory 1104 is calculated in the following way.

(Memory 1104)={32 GB−(9 GB+12 GB)}=11 GB

A detailed description is now given of processing according to this embodiment.

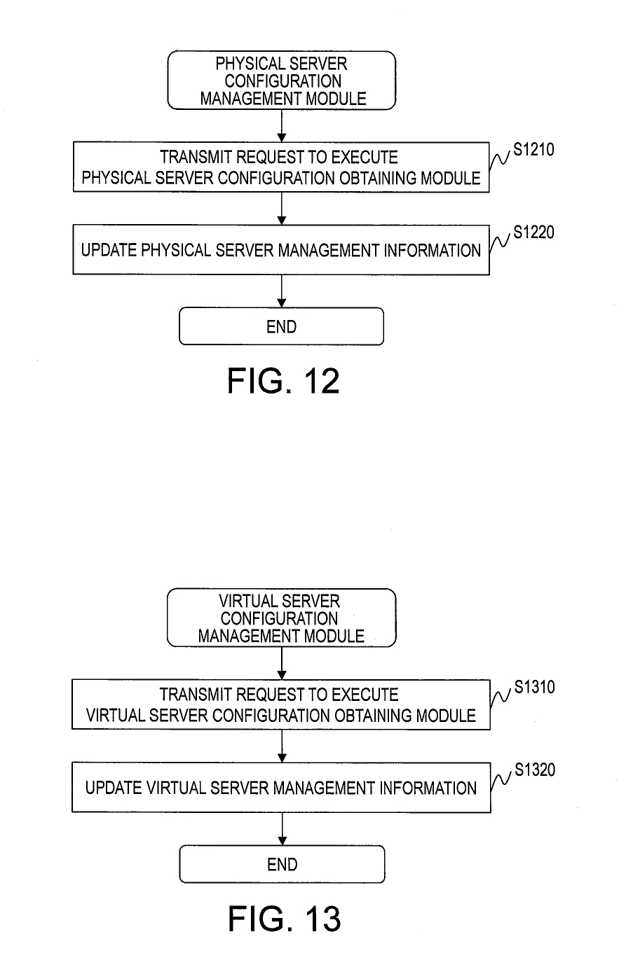

FIG. 12 is a flowchart illustrating the processing executed by the physical server configuration management module 221 according to the first embodiment of this invention.

The physical server configuration management module 221 transmits, to the virtualization module 310 of each of the physical servers 110 subject to management, a request to execute the physical server configuration obtaining module 311 (Step 1210).

It should be noted that the physical servers 110 subject to management may be all the physical servers 110 coupled to the management server 100, or may be physical servers 110 specified in advance for each of applications executed by the OS 330. The physical server 110 subject to management is hereinafter also referred to as subject physical server 110.

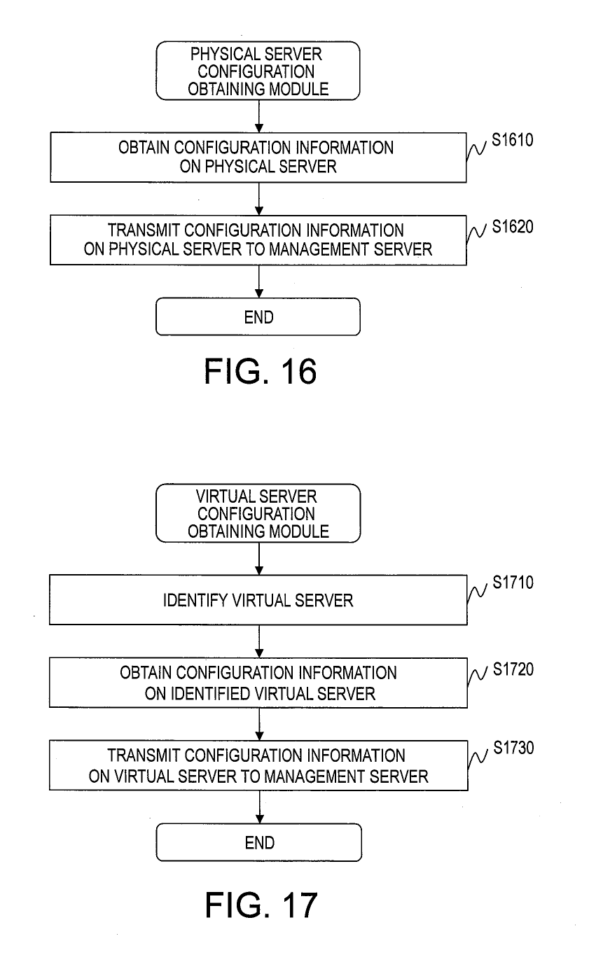

Each of the virtualization modules 310 which has received the execution request executes the physical server configuration obtaining module 311. As a result, the configuration information on the subject physical server 110 is obtained. It should be noted that, referring to FIG. 16, a description is later given of processing executed by the physical server configuration obtaining module 311.

The physical server configuration management module 221 obtains the configuration information on the subject physical server 110 from each of the virtualization modules 310, and updates the physical server management information 230 based on the obtained configuration information on the physical server 110 (Step 1220).

For example, an entry corresponding to the obtained configuration information on the subject physical server 110 is added to the physical server management information 230.

It should be noted that the physical server configuration management module 221 executes the above-mentioned processing, in a case where the computer system is configured. Moreover, in a case where such a notification that the configuration of the computer system has been changed is received, the physical server configuration management module 221 may execute the above-mentioned processing. Moreover, the physical server configuration management module 221 may periodically execute the above-mentioned processing.

FIG. 13 is a flowchart illustrating the processing executed by the virtual server configuration management module 222 according to the first embodiment of this invention.

The virtual server configuration management module 222 transmits, to the virtualization module 310 of each of the subject physical servers 110, a request to execute the virtual server configuration obtaining module 312 (Step 1310).

Each of the virtualization modules 310 which has received the execution request executes the virtual server configuration obtaining module 312. As a result, the configuration information on the virtual server 150 which is managed by the virtualization module 310 is obtained. It should be noted that, referring to FIG. 17, a description is later given of processing executed by the virtual server configuration obtaining module 312.

The virtual server configuration management module 222 obtains the configuration information on the virtual server 150 from each of the virtualization modules 310, and updates the virtual server management information 240 based on the obtained configuration information on the virtual server 150 (Step 1320).

For example, an entry corresponding to the obtained configuration information on the virtual server 150 is added to the virtual server management information 240.

It should be noted that the virtual server configuration management module 222 executes the above-mentioned processing, in a case where the virtual server 150 is configured. Moreover, in a case where such a notification that the configuration of the virtual server 150 has been changed is received, the virtual server configuration management module 222 may execute the above-mentioned processing. Moreover, the virtual server configuration management module 222 may periodically execute the above-mentioned processing.

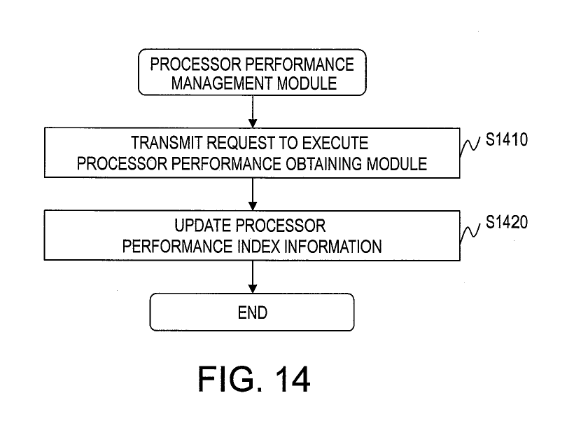

FIG. 14 is a flowchart illustrating the processing executed by the processor performance management module 212 according to the first embodiment of this invention.

The processor performance management module 212 transmits, to the virtualization module 310 of each of the subject physical servers 110, a request to execute the processor performance obtaining module 313 (Step 1410).

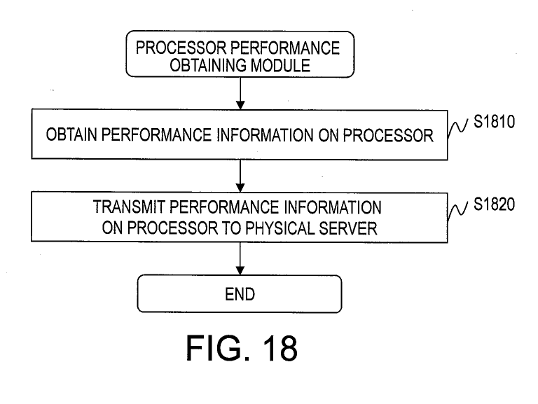

Each of the virtualization modules 310 which has received the execution request executes the processor performance obtaining module 313. As a result, the performance information on the processor 301 included in the physical server 110 on which the virtualization module 310 is operating is obtained. It should be noted that, referring to FIG. 18, a description is later given of the processing executed by the processor performance obtaining module 313.

The processor performance management module 212 obtains the performance information on the processor 301 from each of the virtualization modules 310, and updates the processor performance index information 270 based on the obtained performance information on the processor 301 (Step 1420).

For example, an entry corresponding to the obtained performance information on the processor 301 is added to the processor performance index information 270.

It should be noted that the processor performance management module 212 may periodically execute the above-mentioned processing, or may execute the above-mentioned processing based on a command by an administrator operating the management server 100.

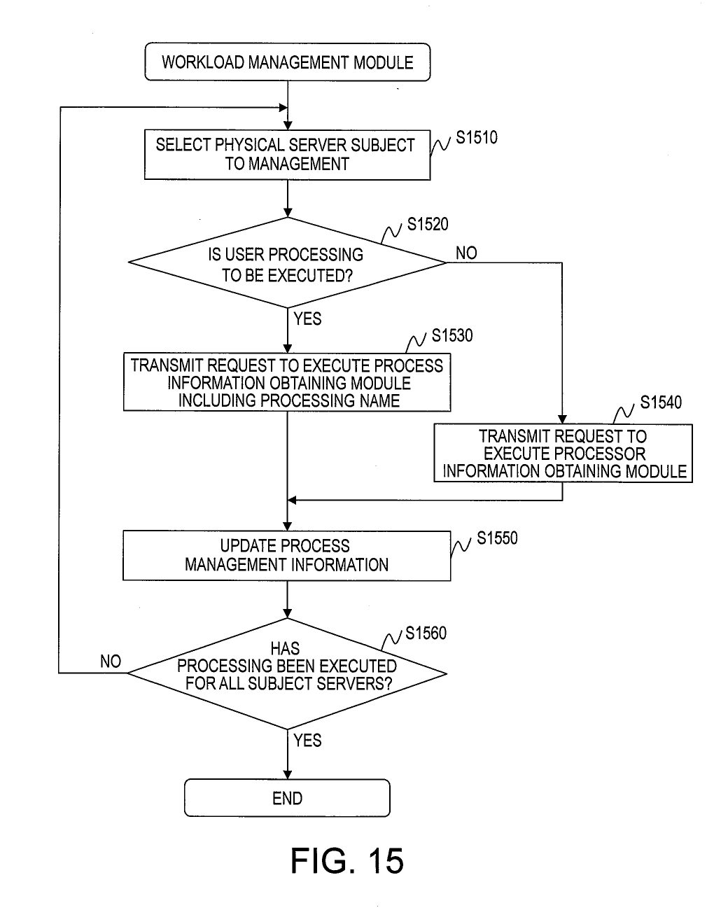

FIG. 15 is a flowchart illustrating the processing executed by the workload management module 211 according to the first embodiment of this invention.

The workload management module 211 selects one physical server 110 out of the subject physical servers 110 (Step 1510).

Then, the workload management module 211 refers to the user-defined information 260, and determines whether or not a virtual server 150 on the selected physical server 110 executes processing specified by a user (Step 1520). The processing specified by the user is hereinafter also referred to as user processing.

In a case where it is determined that the virtual server 150 executes the user processing, the workload management module 211 transmits, to the virtual server 150 operating on the selected physical server 110, a request to execute the process information obtaining module 340 (Step 1530). It should be noted that the execution request includes a processing name 703 corresponding to the user processing.

The virtual server 150 which has received the execution request executes the process information obtaining module 340. As a result, processing information on the user processing is obtained.

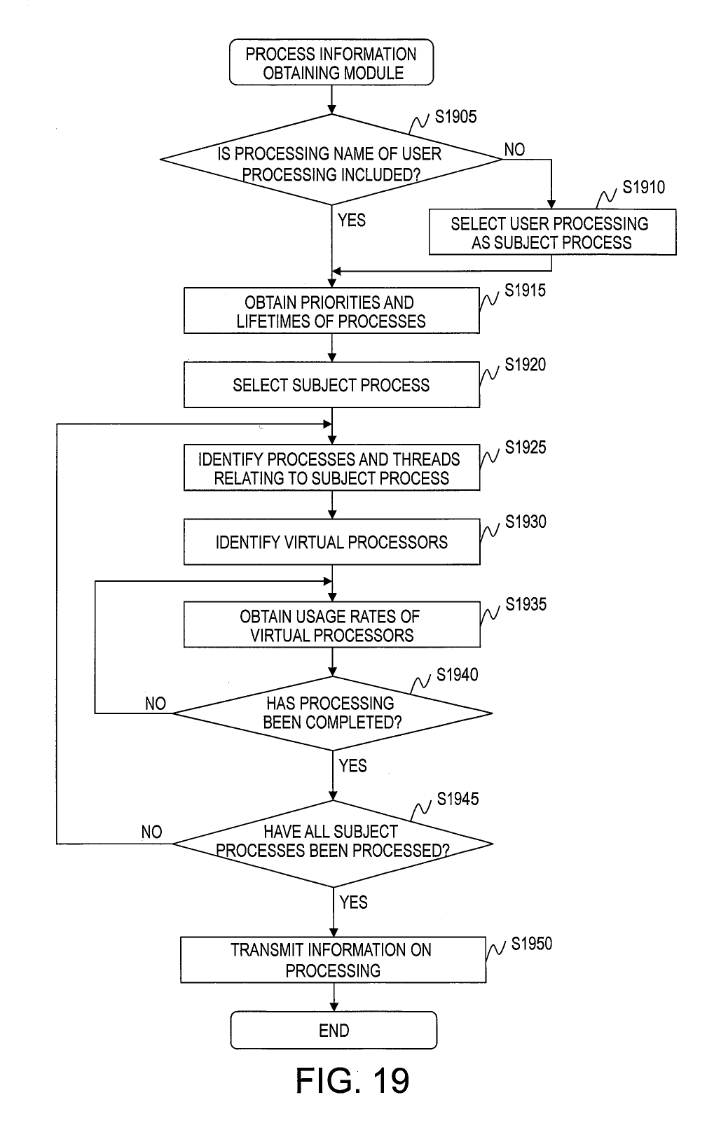

It should be noted that, referring to FIG. 19, a description is later given of the processing executed by the process information obtaining module 340.

In a case where it is determined that there is no virtual server for executing the user processing, the workload management module 211 transmits, to all the virtual servers 150 operating on the selected physical server 110, a request to execute the process information obtaining module 340 (Step 1540).

Each of the virtual servers 150 which has received the execution request executes the process information obtaining module 340. As a result, processing information on processing executed on all the virtual servers 150 on the selected physical server 110 is obtained.

It should be noted that, referring to FIG. 19, a description is later given of the processing executed by the process information obtaining module 340.

The workload management module 211 obtains the processing information from each of the virtual servers 150, and updates the process management information 250 based on the obtained processing information (Step 1550).

For example, an entry corresponding to the obtained processing information is added to the process management information 250.

The workload management module 211 determines whether or not the processing has been executed for all the subject physical servers 110 (Step 1560).

In a case where it is determined that the processing has not been executed for all the subject physical servers 110, the workload management module 211 returns to Step 1510, and executes the same processing.

In a case where it is determined that the processing has been executed for all the subject physical servers 110, the workload management module 211 ends the processing.

It should be noted that the workload management module 211 may periodically execute the above-mentioned processing, or may execute the above-mentioned processing based on a command by the administrator operating the management server 100.

FIG. 16 is a flowchart illustrating the processing executed by the physical server configuration obtaining module 311 according to the first embodiment of this invention.

The virtualization module 310 which has received from the management server 100 the request to execute the physical server configuration obtaining module 311 executes the physical server configuration obtaining module 311.

The physical server configuration obtaining module 311 obtains, from the physical server configuration information 314, the configuration information on the physical server 110 (Step 1610).

The obtained configuration information on the physical server 110 includes the resource amount of the processor 301 and the resource amount of the memory 302 included in the physical server 110.

The physical server configuration obtaining module 311 transmits the obtained configuration information on the physical server 110 to the management server 100 (Step 1620). It should be noted that the transmitted configuration information on the physical server 110 includes the identifier of the physical server 110.

FIG. 17 is a flowchart illustrating the processing executed by the virtual server configuration obtaining module 312 according to the first embodiment of this invention.

The virtualization module 310 which has received from the management server 100 the request to execute the virtual server configuration obtaining module 312 executes the virtual server configuration obtaining module 312.

The virtual server configuration obtaining module 312 identifies virtual servers 150 generated on the physical server 110 (Step 1710). The following processing is executed for each of the identified virtual servers 150.

Specifically, the virtual server configuration obtaining module 312 refers to the virtual server configuration information 315 to obtain the identifier of the virtual server 150 generated on the physical server 110.

The virtual server configuration obtaining module 312 obtains the configuration information on the identified virtual server 150 (Step 1720).

Specifically, the virtual server configuration obtaining module 312 obtains the configuration information on the virtual server 150 by referring to the virtual server configuration information 315 based on the obtained identifier of the virtual server 150.

The configuration information to be obtained on the virtual server 150 includes the resource amounts of the virtual processors 511 and the resource amounts of the virtual memories 512 assigned to the virtual server 150, the assignment method for the processors 301, and a usage state of the virtual server 150.

The virtual server configuration obtaining module 312 transmits, to the management server 100, the obtained configuration information on the virtual server 150 (Step 1730), and ends the processing.

In a case where the processing has not been executed for all the virtual servers 150, the virtual server configuration obtaining module 312 returns to Step 1710, and executes the same processing (Steps 1710 to 1730).

FIG. 18 is a flowchart illustrating the processing executed by the processor performance obtaining module 313 according to the first embodiment of this invention.

The virtualization module 310 which has received from the management server 100 the request to execute the processor performance obtaining module 313 executes the processor performance obtaining module 313.

The processor performance obtaining module 313 obtains the performance information on the processor 301 included in the physical server 110 (Step 1810).

As a method of obtaining the performance information on the processor 301, a method of executing, by the processor performance obtaining module 313, a predetermined a micro benchmark to obtain a result of the micro benchmark as the performance information on the processors 301 is conceivable. It should be noted that a method of holding, by the virtualization module 310, a performance table on the processor 301, and obtaining the performance information on the processor 301 from the performance table may be used.

A program for executing the micro benchmark may be held in advance by each of the physical servers 110, or a program for executing the micro benchmark transmitted by the management server 100 may be used.

According to this embodiment, the performance index is obtained as the performance information on the processor 301.

The processor performance obtaining module 313 transmits, to the management server 100, the obtained performance information on the processor 301 (Step 1820), and ends the processing.

FIG. 19 is a flowchart illustrating the processing executed by the process information obtaining module 340 according to the first embodiment of this invention.

Described below is a case where the process 350 and the thread 360 are executed by the OS 330.

The virtualization module 310 which has received from the management server 100 the request to execute the process information obtaining module 340 executes the process information obtaining module 340.

The process information obtaining module 340 determines whether or not the received execution request includes a processing name 703 (Step 1905).

In a case where it is determined that the received execution request includes a processing name 703, the process information obtaining module 340 selects user processing corresponding to the processing name 703 as a subject from which the processing information on the process 350 is to be obtained (Step 1910), and proceeds to Step 1915.

The process 350 subject to the obtaining of the processing information is hereinafter also referred to as subject process 350.

In a case where it is determined that the received execution request does not include a processing name 703, the processing information obtaining module 340 obtains priorities and lifetimes of all processes 350 executed by the OS 330 (Step S1915). As a result, information corresponding to the priorities 607 and the lifetimes 610 of the processes 350 is obtained.

It should be noted that the priority and the lifetime of the process 350 can be obtained by means of a publicly known technology, and a description thereof is therefore omitted.

The process information obtaining module 340 selects a subject process 350 based on the obtained priorities and lifetimes of the processes 350 (Step 1915).

For example, a method of selecting a process 350 having a priority of “high” and a lifetime of “1 day or more” as the subject process 350 is conceivable. It should be noted that the selection method for the process is not limited to this method, and there may be used a method of determining the subject process 350 based on criteria specified by the administrator operating the management server 100. It should be noted that a plurality of subject processes 350 may be selected.

The processing from Step 1925 to Step 1950 is executed for each of the subject processes 350.

The process information obtaining module 340 identifies processes 350 and threads 360 related to the subject process 350 (Step 1925). It should be noted that the processes 350 and the threads 360 related to the subject process 350 can be identified by means of a publicly known technology, and a description thereof is therefore omitted.

As a result, pieces of information corresponding to the process ID 603, the thread ID 604, the processing name 605, the parent-child relationship 606, the priority 607, and the lifetime 610 are obtained.

The subject process 350 and the processes 350 and the threads 360 related to the subject process 350 are hereinafter also referred to as related processing.

Then, the process information obtaining module 340 identifies, for each of the pieces of the related processing, a virtual processor 511 executing the related processing (Step 1930). As a result, information corresponding to the core IDs 608 is obtained.

The virtual processor 511 for executing the related processing is hereinafter also referred to as subject virtual processor 511.

The process information obtaining module 340 obtains a usage rate for each of the subject virtual processors 511 (Step 1935). As a result, information corresponding to the usage rates 609 is obtained.

According to this embodiment, an average value is obtained as the usage rate of the subject virtual processor 511. It should be noted that the process information obtaining module 340 may obtain the maximum value of the usage rate in the lifetime as the usage rate of the subject virtual processor 511.

The process information obtaining module 340 determines whether or not the usage rate of the subject virtual processor 511 has been obtained (Step 1940).

For example, a method of setting a monitoring time in advance, and determining whether or not a time corresponding to the monitoring time has elapsed after the obtaining of the usage rate of the subject virtual processor 511 started is conceivable. In this case, the monitoring time is a time corresponding to the obtaining time 611.

Moreover, when all the processes 350 and threads 360 included in the related processing group have been finished, it may be determined that the usage rate of the subject virtual processor 511 has been obtained. In this case, a time from a start time of obtaining the usage rate of the subject virtual processor 511 to an end time of the subject process 350 or the like corresponds to the obtaining time 611.

In a case where it is determined that the usage rate of the subject virtual processor 511 has not been obtained, the process information obtaining module 340 returns to Step 1935, and executes the same processing.

In a case where it is determined that the usage rate of the subject virtual processor 511 has been obtained, the process information obtaining module 340 determines whether or not all the subject processes 350 have been processed (Step 1945).

In a case where it is determined that all the subject processes 350 have not been processed, the process information obtaining module 340 returns to Step 1925, and executes the same processing.

In a case where it is determined that all the subject processes 350 have been processed, the process information obtaining module 340 transmits the obtained processing information to the management server 100 (Step 1950), and ends the processing.

It should be noted that the processing information to be transmitted includes the OS types, the process IDs, the thread IDs, the processing names, the parent-child relationships, the core IDs, the processor usage rates, the lifetimes, and the obtained times.

According to this embodiment, all processes are not subject to the processing, but in Steps 1910 to 1925, the usage rates of the virtual processors 511 are calculated for the limited processes 350 and threads 360 satisfying the predetermined conditions. In other words, important services are identified, and resource amounts used by the services are calculated.

It should be noted that this invention is not limited to this configuration, and all the processes may be subject to the processing.

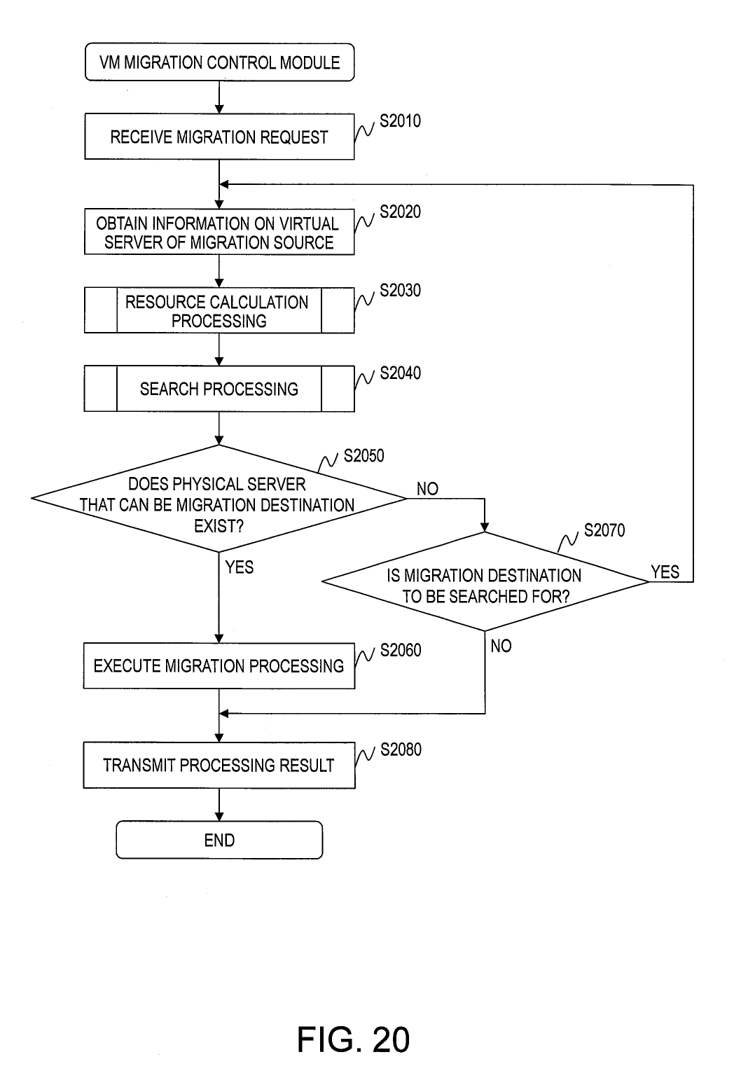

FIG. 20 is a flowchart illustrating the processing executed by the VM migration control module 213 according to the first embodiment of this invention.

In a case where the management server 100 receives a migration request for the virtual server 150 from a user providing a service by using the virtual servers 150 or the administrator operating the management server 100, the management server 100 executes the VM migration control module 213 (Step 2010).

It should be noted that the migration request includes the identifier of the virtualization module 310 subject to the migration, and the identifier of the virtual server 150.

The VM migration control module 213 obtains information relating to the virtual server 150 of migration source from the virtual server management information 240 and the process management information 250 (Step 2020).

Specifically the VM migration control module 213 refers to the virtual server management information 240 and the process management information 250 based on the identifier of the virtual server 150 included in the migration request.

Further, the VM migration control module 213 obtains, from the virtual server management information 240 and the process management information 250, information stored in entries including an identifier matching the identifier of the virtual server 150 included in the migration request.

Then the VM migration control module 213 executes resource calculation processing for calculating used resource amounts of the virtual server 150 based on the obtained information on the virtual server 150 (Step 2030).

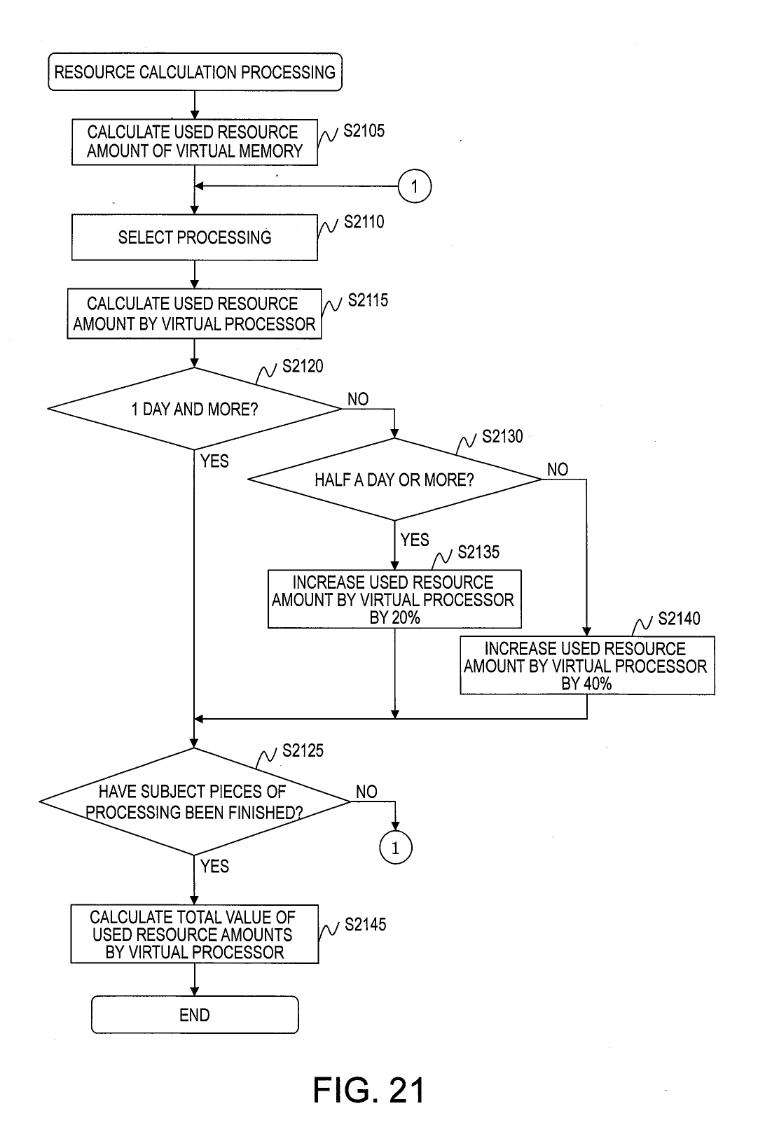

It should be noted that, referring to FIG. 21, a detailed description is later given of the resource calculation processing.

The VM migration control module 213 executes search processing for searching for a physical server 110 of migration destination based on the calculated used resource amounts of the virtual server 150 (Step 2040).

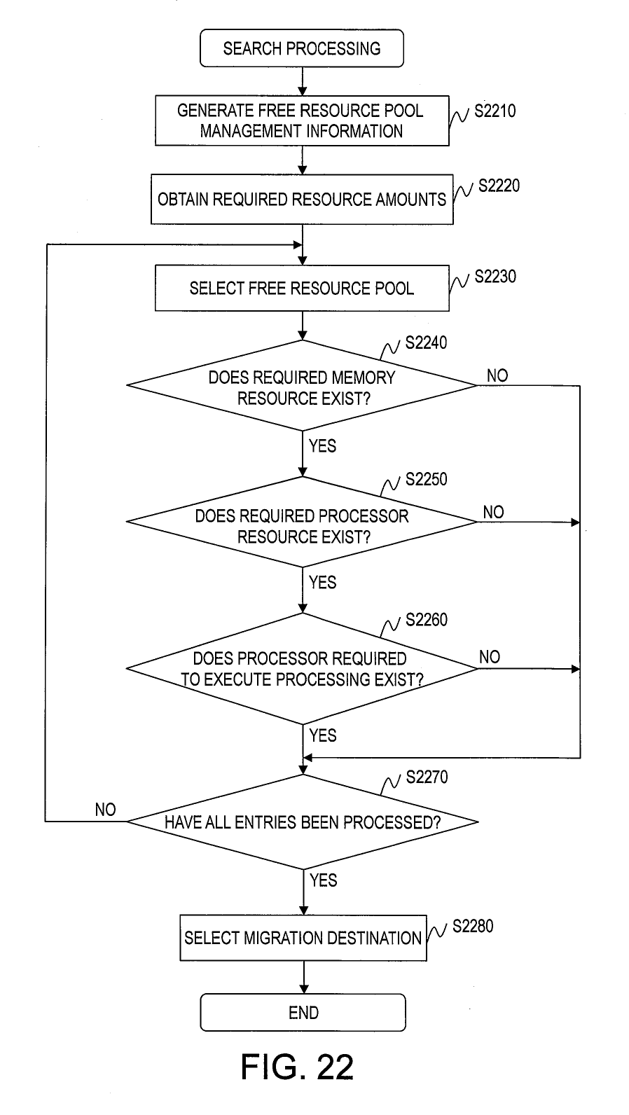

It should be noted that, referring to FIG. 22, a detailed description is later given of the search processing.

The VM migration control module 213 determines, based on the search result, whether or not a physical server 110 which can be a migration destination exists (Step 2050).

In a case where a physical server 110 which can be a migration destination does not exist, the VM migration control module 213 asks the user or the administrator whether or not continue the search processing (Step 2070).

As the confirmation method, a method of displaying an instruction screen for selecting whether or not to continue the search processing on a display coupled to the management server 100 or the like is conceivable.

In a case where an instruction to continue the search processing is received, the VM migration control module 213 returns to Step 2020, and executes the same processing. It should be noted that the processing may be immediately started, or the processing may be started after a predetermined time has elapsed.

In a case where the VM migration control module 213 receives such a notification that the search processing is not to be continued, the VM migration control module 213 notifies the user or the administrator of the state where a virtual server 110 which can be a migration destination does not exist (Step 2080), and ends the processing.

In Step 2050, in a case where the VM migration control module 213 determines that a physical server 110 which can be migration destination exists, the VM migration control module 213 executes the migration processing (Step 2060). As a result, the subject virtual server 150 is migrated to the physical server 110 of migration destination.

As the migration processing, for example, the following method is conceivable.

The management server 100 instructs the VM migration control module 213 of the physical server 110 of migration destination to allocate the resources required for the subject virtual server 150. The VM migration control module 213 of the physical server 110 of migration destination which has received the instruction sets required information, and transmits to the management server 100 a notification indicating such a state that the resources have been allocated.

After the management server 100 receives, from the physical server 110 of migration destination, the notification representing such a state that the resources have been allocated, the management server 100 instructs the VM migration control module 213 of the physical server 110 of migration source to migrate the virtual server 150.

The VM migration control module 213 of migration source which has received the instruction transmits data of the virtual server 150 to the physical server 110 of migration destination.

After the virtual server 150 has migrated to the physical server 110 of migration destination, the VM migration control module 213 notifies the user or the administrate of such a state that the migration processing has been completed (Step 2080), and ends the processing.

FIG. 21 is a flowchart illustrating details of the resource calculation processing according to the first embodiment of this invention.

The VM migration control module 213 calculates the used resource amount of the virtual memory 512 used by the virtual server 150 subject to the migration (Step 2105).

Specifically, the VM migration control module 213 reads, from the virtual server management information 240, the virtual memory 907 of an entry matching the identifier of the virtualization module 310 and the identifier of the virtual server 150 included in the migration request. The VM migration control module 213 calculates a value stored in the read virtual memory 907 as a used resource amount of the virtual memory 512.

Then, the VM migration control module 213 selects one of pieces of processing to be executed on the virtual server 150 subject to the migration (Step 2110).

Specifically, the VM migration control module 213 selects, from the process management information 250, one of entries matching the identifier of the virtual server 150 included in the migration request.

Subsequently, in Steps 2115 to 2140, the used resource amounts of the virtual processors 511 used by the selected processing are calculated.

The VM migration control module 213 calculates a used resource amount of a virtual processor 511 to be used by the selected processing (Step 2115).

Specifically, the VM migration control module 213 reads the usage rate 609 of the corresponding processing from the process management information 250, and reads the virtual processor 906 of the corresponding processing from the virtual server management information 240.

The VM migration control module 213 calculates, by multiplying the read usage rate 609 and the clock frequency included in the read virtual processor 906 by each other, the used resource amount by the virtual processor 511 to be used by the selected processing.

For example, if the virtualization module ID 901 is “hyper1”, the virtual server ID 902 is “virt1”, and the processing name 605 is “pname1”, the used resource amount is calculated in the following way.

1.7 GHz×0.5=0.85 GHz

Then, the VM migration control module 213 refers to the process management information 250 to determine whether or not the obtaining time 611 corresponding to the selected processing is equal to or more than one day (Step 2120).

In a case where it is determined that the obtaining time 611 corresponding to the selected processing is equal to or more than one day, the VM migration control module 213 proceeds to Step 2125.

In a case where it is determined that the obtaining time 611 corresponding to the selected processing is less than one day, the VM migration control module 213 determines whether or not the obtaining time 611 corresponding to the selected processing is equal to or more than half a day (Step 2130).

In a case where it is determined that the obtaining time 611 corresponding to the selected processing is equal to or more than half a day, the VM migration control module 213 increases the used resource amount of the virtual processor 511 calculated in Step 2115 by 20% (Step 2135). Then, the VM migration control module 212 proceeds to Step 2125.

In a case where it is determined that the obtaining time 611 corresponding to the selected processing is less than half a day, the VM migration control module 213 increases the used resource amount of the virtual processor 511 calculated in Step 2115 by 40% (Step 2140). Then, the VM migration control module 212 proceeds to Step 2125.

The VM migration control module 213 refers to the process management information 250 to determine whether or not the calculation processing has been finished for the subject pieces of processing of the virtual server 150 subject to the migration (Step 2125).

In a case where it is determined that the calculation processing has not been finished for all the pieces of processing of the virtual server 150 subject to the migration, the VM migration control module 213 returns to Step 2110, selects next processing, and executes the same calculation processing.

In a case where it is determined that the calculation processing has been finished for all the pieces of processing of the virtual server 150 subject to the migration, the VM migration control module 213 calculates a total value of the used resource amounts of the virtual processors 511 to be used by the respective pieces of subject processing (Step 2145), and ends the processing.

The value calculated in Step 2145 is the used resource amount of the virtual processors 511 used by the virtual server 150 subject to the migration.

It should be noted that the value calculated by the resource calculation processing is temporality held by the VM migration control module 213.

The processing in Step 2120, and in Steps 2130 to 2140 depends on a reliability of the obtained used resource of each of the subject pieces of processing. A load may temporarily increase when the information is obtained, and if the time for obtaining the processing information is short, the information is not necessarily accurate.

Therefore, according to this embodiment, estimation of the used resource amount depending on the obtained time is increased, specifically, an extra used resource amount is added, so as to provide the computer resource required for the migration destination with a margin.

The unit of the obtaining time is not limited to a day or half a day. Moreover, a different determination criterion may be used for each of the OSs 330 and the processes 350.

This embodiment has a feature in that the resource amounts to be used by each of the subject pieces of processing on the virtual server 150 subject to the migration are calculated. In other words, out of the pieces of processing executed on the virtual server 150, resource amounts used by important pieces of processing (services) are calculated as the resource amounts required for the virtual server 150. As a result, more physical servers 110 can be selected as the migration destination.

The used resource amount of the virtual processor 511 calculated by the resource calculation processing is hereinafter also referred to as required processor resource amount, and the used resource amount of the virtual memory 512 is hereinafter also referred to as required memory resource amount. Moreover, the required processor resource amount and the required memory resource amount are hereinafter also generally referred to as required resource amount.

FIG. 22 is a flowchart illustrating details of the search processing according to the first embodiment of this invention.

The VM migration control module 213 generates the free resource pool management information 280 based on the physical server management information 230, the virtual server management information 240, and the processor performance index information 270 (Step 2210).

Specifically, the following processing is executed.

First, the VM migration control module 213 calculates the resource amounts assigned to each of the virtual servers 150 on the virtualization module 310. Then, the VM migration control module 213 sums the resource amounts assigned to the respective virtual servers 150. As a result, the used resource amounts in the virtualization module 310 are calculated.

For example, if the virtualization module ID 901 is “hyper 1”, a total value of the resources assigned to the virtual processors 511 of the respective virtual servers 150 is calculated as “15.3 GHz”, and a total value of the resource assigned to the virtual memories 512 of the respective virtual servers 150 is calculated as “21 GB”.

From each of the resource amounts included in the physical server 110 on which the virtualization module 310 is operating, each of the used resource amounts on the virtualization module 310 is subtracted.

Further, the resource amount of the processor is multiplied by the performance index 1003. The values calculated by the above-mentioned processing are stored in the processor 1103 and the memory 1104 of the free resource pool management information 280.

The VM migration control module 213 obtains the required resource amounts (Step 2220).

Then, the VM migration control module 213 refers to the free resource pool management information 280, and selects one of the free resource pools (Step 2230). As the selection method, a method of sequentially selecting an entry starting from the top entry in the free resource pool management information 280 is conceivable. Other selection method may be used.

The VM migration control module 213 determines whether or not a resource amount equal to or more than the required memory resource amount exists in the selected free resource pool (Step 2240).

Specifically, in a case where the value stored in the memory 1104 is equal to or more than the required memory resource amount, it is determined that a resource amount equal to or more than the required memory resource amount exists in the free resource pool.

In a case where it is determined that a resource amount equal to or more than the required memory resource amount does not exist in the selected free resource pool, the VM migration control module 213 proceeds to Step 2270.

In a case where it is determined that a resource amount equal to or more than the required memory resource amount exists in the selected free resource pool, the VM migration control module 213 determines whether or not a resource amount equal to or more than the required processor resource amount exists in the selected free resource pool (Step 2250).

Specifically, in a case where the value stored in the processor 1103 is equal to or more than the required processor resource amount, it is determined that a resource amount equal to or more than the required processor resource amount exists in the free resource pool.

In a case where it is determined that a resource amount equal to or more than the required processor resource amount does not exist in the selected free resource pool, the VM migration control module 213 proceeds to Step 2270.

In a case where it is determined that a resource amount equal to or more than the required processor resource amount exists in the selected free resource pool, the VM migration control module 213 determines whether or not the selected free resource pool includes a processor which can execute the processing to be executed on the virtual server 150 subject to the migration (Step 2260).

Specifically, it is determined whether or not the clock frequency of the processor 301 included in the free resource pool is equal to or more than the clock frequency of the processor core included in the virtual processor 511.

For example, in a case where the clock frequency of the processor cores included in the virtual processor 511 is “1.2 GHz”, and the clock frequency of the processor 301 included in the free resource pool is “1.7 GHz”, it is determined that a processor required for the processing to be executed on the virtual server 150 subject to the migration is included.

In a case where it is determined that the free resource pool does not include a processor required for the processing to be executed on the virtual server 150 subject to the migration, the VM migration control module 213 proceeds to Step 2270.

In a case where it is determined that the free resource pool includes a processor required for the processing to be executed on the virtual server 150 subject to the migration, the VM migration control module 213 selects the selected virtualization module 310 as a candidate of the virtualization module 310 which can be a migration destination. The candidate of the virtualization module 310 which can be a migration destination is hereinafter also referred to as candidate virtualization module 310.

The VM migration control module 213 determines whether or not the search processing has been executed for all the entries in the free resource pool management information 280 (Step 2270).

In a case where it is determined that the search processing has not been finished for all the entries of the free resource pool management information 280, the VM migration control module 213 returns to Step 2230, selects another entry, and executes the same calculation processing.

In a case where it is determined that the search processing has been finished for all the entries of the free resource pool management information 280, the VM migration control module 213 selects a virtualization module 310 serving as the migration destination from the candidate virtualization modules 310 (Step 2280), and ends the processing.

In a case where there are a plurality of candidate virtualization modules 310, the VM migration control module 213 refers to the virtual server management information 240. The VM migration control module 213 selects the virtualization module 310 of migration destination based on the number of virtual servers 150 on the candidate virtualization module 310 and the assignment method 904.

For example, a method of selecting, in priority, a candidate virtualization module 310 on which the number of virtual servers 150 having “shared” as the assignment method 904 is large is conceivable. It should be noted that this invention is not limited to this method, and other method can be used to provide the same effect.

It should be noted that though resources which are not assigned to the virtual servers 150 are managed as the free resource pool, this invention is not limited to this configuration. For example, resources which are assigned to virtual servers 150 which are not used may be included in the free resource pool.

It should be noted that the virtualization module 310 of migration destination executes processing for operating the virtual server 150 to be migrated. For example, the virtualization module 310 executes processing of allocating resources required by the virtual server 150.

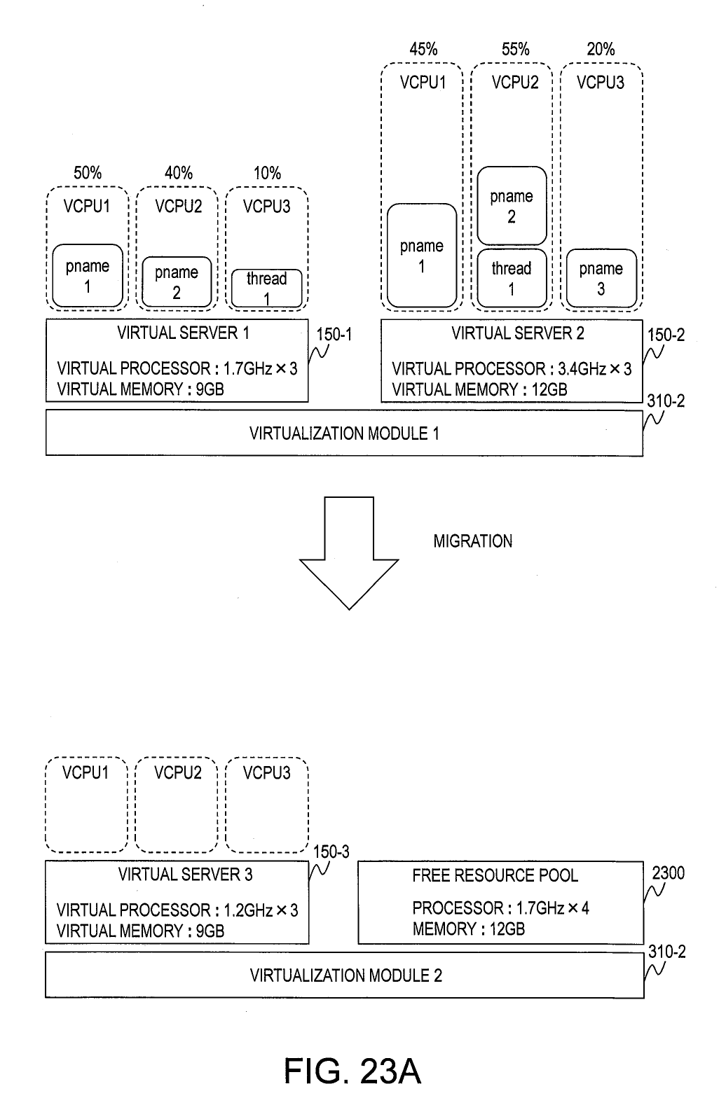

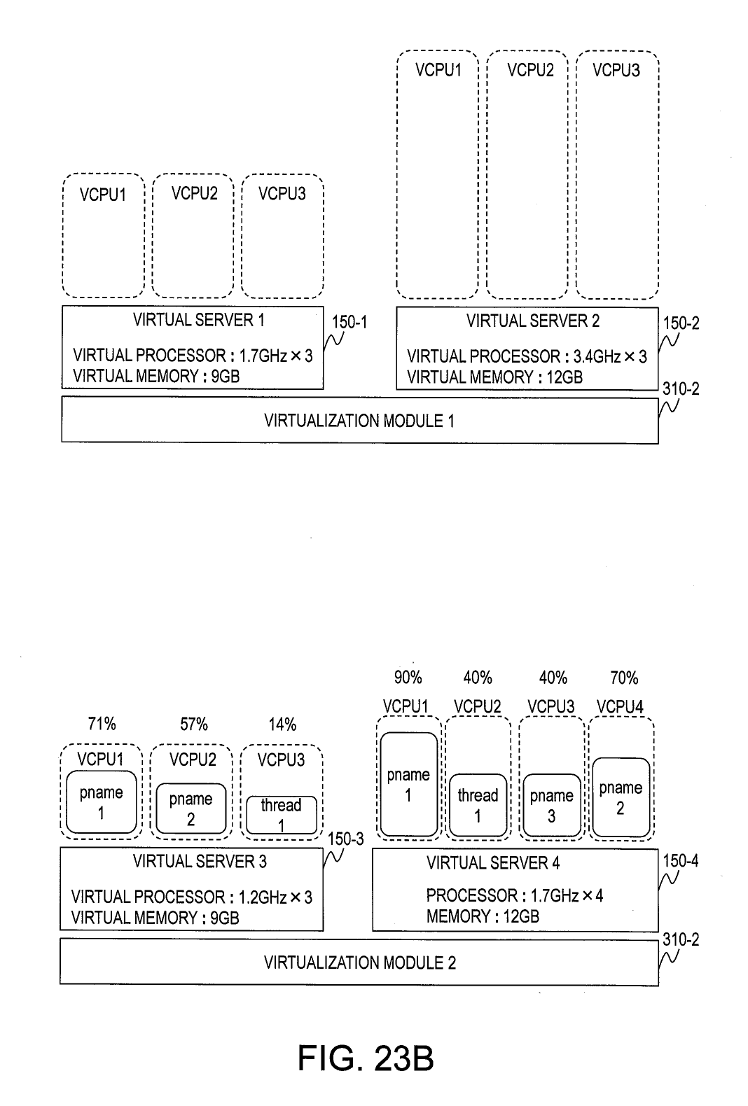

FIGS. 23A and 23B are explanatory diagrams illustrating application examples of the first embodiment of this invention.

FIG. 23A illustrates states of a virtualization module 1 (310-1) of migration source and a virtualization module 2 (310-2) of migration destination before the migration.

On the virtualization module 1 (310-1), a virtual server 1 (150-1) and a virtual server 2 (150-2) are operating.

The virtual server 1 (150-1) has the resource amount “1.7 GHz×3” as the resource amount of the virtual processor 511, and the resource amount “9 GB” as the resource amount of the virtual memory 512. Moreover, the virtual server 1 (150-1) includes, as the virtual processors 511, VCPU1, VCPU2, and VCPU3. The respective frequencies of the virtual processors 511 are 1.7 GHz.

VCPU1 executes a process 350 having a process name “pname1”, and the usage rate by the process 350 is 50%. VCPU2 executes a process 350 having a process name “pname2”, and the usage rate by the process 350 is 40%. Moreover, VCPU3 executes a thread 360 having a process name “thread 1”, and the usage rate by the thread 360 is 10%.

The virtual server 2 (150-2) has the resource amount “3.4 GHz×3” as the resource amount of the virtual processor 511, and the resource amount “12 GB” as the resource amount of the virtual memory 512. Moreover, the virtual server 2 (150-2) includes, as the virtual processors 511, VCPU1, VCPU2, and VCPU3. The respective frequencies of the virtual processors 511 are 3.4 GHz.

VCPU1 executes a process 350 having a process name “pname1”, and the usage rate by the process 350 is 45%. VCPU2 executes a process 350 having a process name “pname2” and a thread 360 having a process name “thread1”, and the usage rate by the process 350 and the thread 360 is 40%.

Moreover, VCPU3 executes a process 350 having a process name “pname3”, and the usage rate by the process 350 is 10%.

On the virtualization module 2 (310-2), a virtual server 3 (150-3) is generated. Moreover, the virtualization module 2 (310-2) has a free resource pool 2300.

It should be noted that the virtual server 3 (150-3) is in the unused state. According to this embodiment, resources assigned to the virtual server 3 (150-3) are treated as one free resource pool.

The virtual server 3 (150-3) has the resource amount “1.2 GHz×3” as the resource amount of the virtual processor 511, and the resource amount “9 GB” as the resource amount of the virtual memory 512. Moreover, the virtual server 1 (150-1) includes, as the virtual processors 511, VCPU1, VCPU2, and VCPU3. The respective frequencies of the virtual processors 511 are 1.2 GHz.

Moreover, the free resource pool 2300 has “1.7 GHz×4” as the resource amount of an unused processor 301, and “12 GB” as the resource amount of an unused memory 302.

Conventionally, the migration destination is determined based on a total amount of resources assigned to the virtual server 150. Thus, according to the conventional method, for the virtual server 1 (150-1), the free resource pool 2300 is selected as the migration destination. On the other hand, for the virtual server 2 (150-2), it is determined that a migration destination does not exist.

Therefore, according to the conventional method, it is determined that the virtual server 1 (150-1) and the virtual server 2 (150-2) operating on the virtualization module 1 (310-2) cannot migrate.

On the other hand, in this embodiment, the resource amount used by the processes 350 and the threads 360 executed on the virtual server 150 is focused on.

The VM migration control module 213 calculates the required processor resource amount as “1.7 GHz” and the required memory resource amount as “9 GB” on the virtual server 1 (150-1).

Therefore, the VM migration control module 213 can also select the virtual server 3 (150-3) as the migration destination.

Moreover, the VM migration control module 213 calculates the required processor resource amount as “3.74 GHz” and the required memory resource amount as “12 GB” on the virtual server 2 (150-2).

Thus, the VM migration control module 213 can select the free resource pool 2300 as the migration destination.

FIG. 23B illustrates states of the virtualization module 1 (310-1) of migration source and the virtualization module 2 (310-2) of migration destination after the migration.

FIG. 23B illustrates an example of a case where the virtual server 1 (150-1) migrates to the virtual server 3 (150-3), and the virtual server 2 (150-2) migrates to the free resource pool 2300.

It should be noted that the virtualization module 2 (310-2) generates a virtual server 4 (150-4) from the free resource pool 2300. The VM migration control module 213 migrates the virtual server 2 (150-2) to the generated virtual server 4 (150-4).

As illustrated in FIG. 23B, processes 350 and threads 360 executed on the virtual servers 150 before the migration continue to be executed on the virtual servers 150 of migration destination.

Though the used amount of the virtual processors 511 by each piece of processing is considered in this embodiment, this invention is not limited to this case. For example, the used amount of the virtual memory 512 by each piece of processing may be considered. In this case, the same method as of the calculation of the required processor resource amount may be used to calculate the required memory resource amount.

### Second Embodiment

In a second embodiment, a description is given of the LPAR method. It should be noted that differences from the first embodiment are mainly described.

Configurations of the computer system, the management server 100, the physical servers 110, and the storage system 120 according to the second embodiment are the same as those of the first embodiment, and a description thereof is therefore omitted.

The LPAR method is different in how to assign resources to the virtual servers 150.

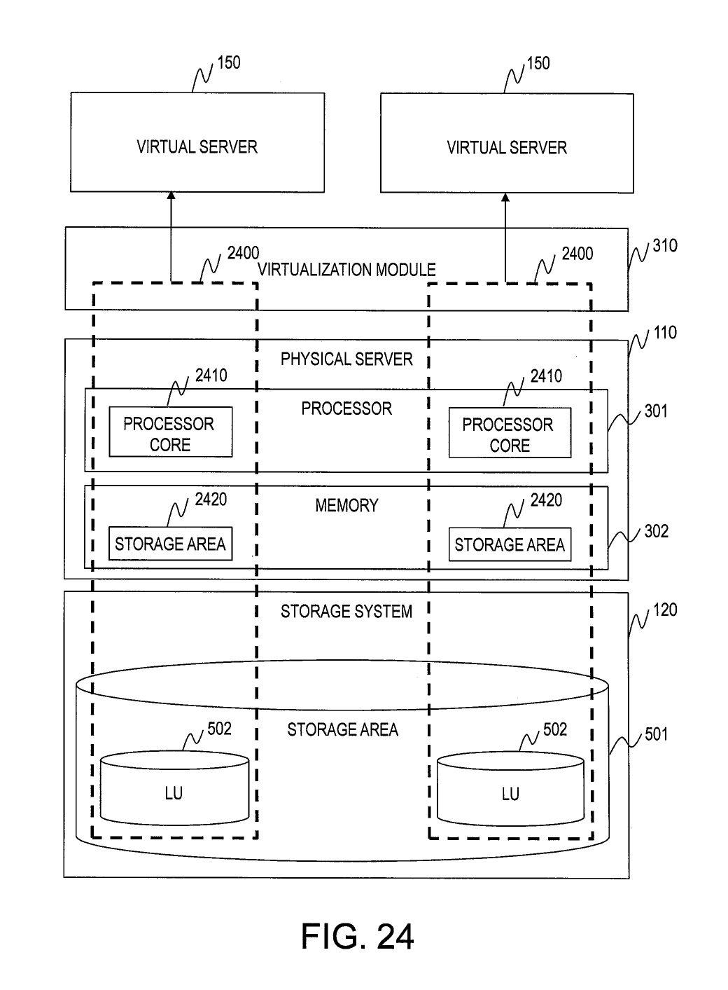

FIG. 24 is an explanatory diagram illustrating a logical configuration of the computer system according to the second embodiment of this invention.

The virtualization module 310 logically divides the resources included in the physical server 110, and assigns an LPAR 2400 constituted by the logically divided resources to the virtual server 150.

In the example illustrated in FIG. 24, the LPAR 2400 includes a processor core 2410, a storage area 2420, and an LU 502. The resources assigned to the LPAR 2400 can be used in a dedicated manner by the LPAR 2400. Therefore, the resources are not used by other LPARs 2400.

It should be noted that resources per processor 301 or resources per memory 302 may be assigned to the LPAR 2400.

The physical server management information 230, the user-defined information 260, and the processor performance index information 270 are the same as those of the first embodiment, and a description thereof is therefore omitted.

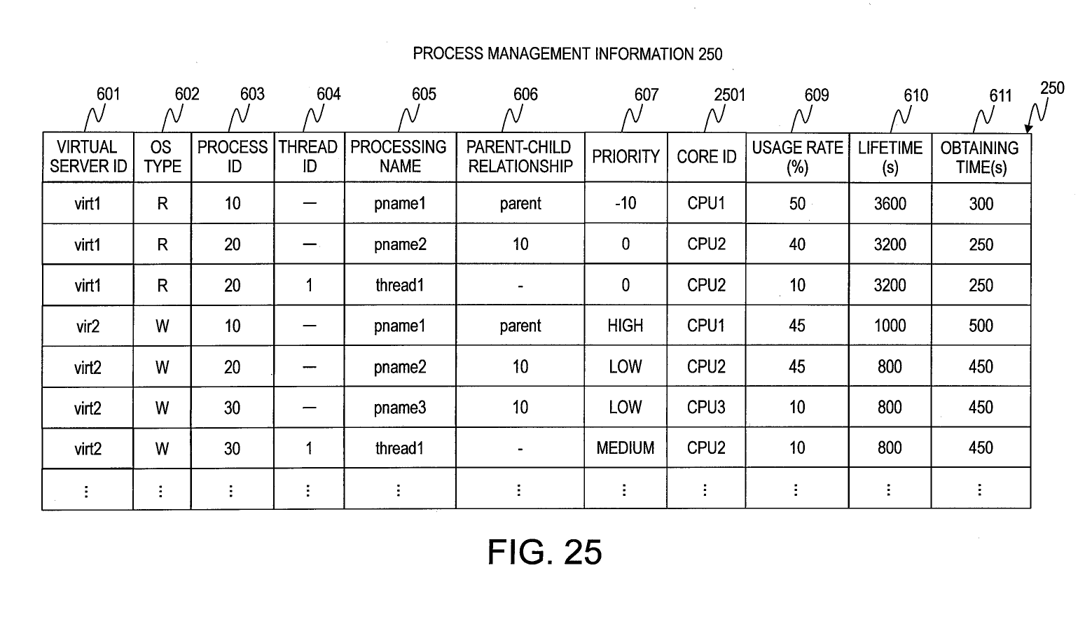

FIG. 25 is an explanatory diagram illustrating an example of the process management information 250 according to the second embodiment of this invention.

The process management information 250 according to the second embodiment is different in information stored in a core ID 2501. In the LPAR method, the processor cores 2410 are directly assigned, and hence, in the core ID 2501, an identifier for identifying the processor cores 2410 is stored.

It should be noted that the virtual server ID 601, the OS type 602, the process ID 603, the thread ID 604, the processing name 605, the parent-child relationship 606, the priority 607, the usage rate 609, the lifetime 610, and the obtaining time 611 are the same as those of the first embodiment.

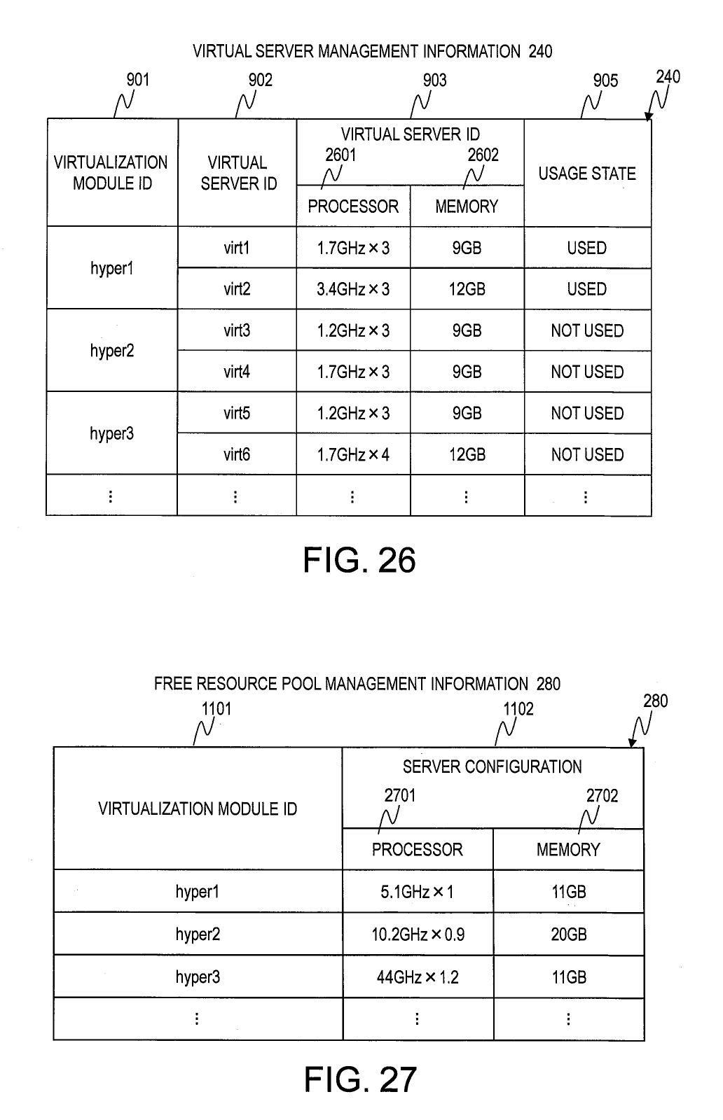

FIG. 26 is an explanatory diagram illustrating an example of the virtual server management information 240 according to the second embodiment of this invention.

The virtual server management information 240 according to the second embodiment is different in information stored in the virtual server configuration 903.

Specifically, in a processor 2601, a value obtained by multiplying the frequency of the processor core 2410 assigned to the LPAR 2400 and the number of the assigned processor cores 2410 by each other. In a memory 2602, the capacity of the storage area 2420 assigned to the LPAR 2400 is stored.

Moreover, the virtual server management information 240 according to the second embodiment does not include the assignment method 904. This is because resources are assigned in the dedicated manner to the LPAR 2400.

It should be noted that the virtualization module ID 901, the virtual server ID 902, and the usage state 905 are the same as those of the first embodiment.

FIG. 27 is an explanatory diagram illustrating an example of the free resource pool management information 280 according to the second embodiment of this invention.

The free resource pool management information 280 according to the second embodiment is different in value stored in the server configuration 1102. In the server configuration 1102, resource amounts which are not assigned to the LPAR 2400 are stored.

The value stored in a processor 2701 is calculated in the following way.

In Step 2210, the VM migration control module 213 subtracts, from the number of all the processor cores 2410 included in the physical server 110, the number of the processor cores 2410 assigned to the LPAR 2400. As a result, the number of the processor cores 2410 which are not assigned to the LPAR 2400 is calculated.

Then, the VM migration control module 213 multiplies the number of the processor cores 2410 which are not assigned to the LPAR 2400 and the clock frequency of the processor cores 2410 by each other.

The VM migration control module 213 further multiplies the calculated value by the performance index 1003 corresponding to the processor cores 2410.

The value calculated by the above-mentioned processing is stored in the processor 2701.

Further, the value stored in a memory 2702 is calculated in the following way.

In Step 2210, the VM migration control module 213 subtracts, from a total capacity of the memory 302 included in the physical server 110, a total storage area assigned to the LPAR 2400. As a result, the capacity of the storage area 2420 which is not assigned to the LPAR 2400 is calculated.

The value calculated by the above-mentioned processing is stored in the memory 2702.

A description is now given of processing different from that of the first embodiment.

The processing executed by the process information obtaining module 340 illustrated in FIG. 19 is different as follows.

In Step 1930, the process information obtaining module 340 identifies, for each of the pieces of the related processing, a processor core 2410 for executing the related processing.

In Step 1935, the process information obtaining module 340 obtains a usage rate of each of the processor cores 2410 for executing the processing.

The other processing is the same as that of the first embodiment.

The resource calculation processing executed by the VM migration control module 213 illustrated in FIG. 21 is different as follows.

In Step 2105, the VM migration control module 213 calculates a used resource amount of the storage area 2420 used by the virtual server 150 subject to the migration.

Specifically, the VM migration control module 213 reads, from the virtual server management information 240, the virtual memory 907 of an entry matching the identifier of the virtualization module 310 and the identifier of the virtual server 150 included in the migration request. The VM migration control module 213 calculates a value to be stored in the read memory 2602 as the used resource amount of the storage area 2420.

In Step 2115, the VM migration control module 213 calculates a used resource amount of a processor core 2410 to be used by the selected processing.

Specifically, the VM migration control module 213 reads, from the process management information 250, the usage rate 609 of the selected processing, and reads, from the virtual server management information 240, the processor 2601 of the virtual server 150 for executing the selected processing.

The VM migration control module 213 calculates, by multiplying the read usage rate 609 and the clock frequency included in the processor 2601 by each other, the used resource amount by the processor core 2410 to be used by the selected processing.

In Step 2135, the VM migration control module 213 increments, by one, the number of processor cores 2410 used by the LPAR 2400.

In Step 2140, the VM migration control module 213 increments, by two, the number of processor cores 2410 used by the LPAR 2400.

The other processing is the same as that of the first embodiment, and a description thereof is therefore omitted.

According to the embodiment of this invention, the resource amounts required for the virtual server 150 are calculated based on the resource amounts used by the processing (processes 350, threads 360, and the like) executed on the virtual server 150. Thus, the virtual server 150 can be migrated to a free resource pool having appropriate resource amounts. Moreover, the number of candidates of the free resource pool of migration destination increases, and the resources can be efficiently used.

What is claimed is:

1. A computer system, comprising:
a plurality of physical computers; and
a management server for managing the plurality of physical computers,
wherein at least one virtual computer operates on each of the plurality of physical computers, which is assigned an assigned resource generated by dividing a computer resource included in the each of the plurality of physical computers into a plurality of parts,
wherein the at least one virtual computer executes at least one piece of service processing including at least one piece of sub processing,
wherein the each of the plurality of physical computers includes: a first processor; a first main storage medium coupled to the first processor; a sub storage medium coupled to the first processor; a first network interface coupled to the first processor; a virtual management module for managing the at least one virtual computer; and a used resource amount obtaining module for obtaining a used resource amount which is information on a used amount of the assigned resource used by executing the at least one piece of service processing,
wherein the management server includes: a second processor; a second storage medium coupled to the second processor; a second network interface coupled to the second processor; a resource information management module for managing resource information including information on the computer resource included in the each of the plurality of physical computers; an assigned resource information management module for managing assigned resource information including information on the assigned resource; an obtaining command module for transmitting a command to obtain the used resource amount to the virtual management module; and a migration processing module for executing migration processing for a virtual computer,
wherein the management server is configured to transmit the obtaining command to a plurality of the virtual computers,
wherein each of the plurality of the virtual computers is configured to:
obtain the used resource amount for each of a plurality of the pieces of sub processing based on the received obtaining command; and
transmit the obtained used resource amount for the each of the plurality of the pieces of sub processing to the management server, and
wherein the management server is configured to:
obtain the resource information and the assigned resource information from the each of the plurality of physical computers;
generate free resource information which is information on a free resource representing an unused computer resource in the computer system based on the obtained resource information and the obtained assigned resource information, in a case where the management server receives a request to execute the migration processing of the virtual computer;
calculate a required resource amount which is a resource amount of a computer resource required for the virtual computer subject to the migration based on the obtained used resource amount for the each of the plurality of the pieces of sub processing;
search for a physical computer of a migration destination based on the generated free resource information and the calculated required resource amount; and
migrate the virtual computer subject to the migration to the physical computer of the migration destination based on a result of the search.

2. The computer system according to claim 1, wherein the management server is configured to:
calculate a total value of the used resource amounts of the plurality of the pieces of sub processing as the required resource amount;
refer to the free resource information to select the free resource;
determine whether a resource amount of the selected free resource is equal to or more than the required resource amount; and
select the physical computer corresponding to the selected free resource as a candidate physical computer serving as the migration destination of the virtual computer subject to the migration, in a case where the resource amount of the selected free resource is equal to or more than the required resource amount.

3. The computer system according to claim 2,
wherein the obtained used resource amount for the each of the plurality of the pieces of sub processing includes an obtaining period representing a period in which the used resource amount has been obtained, and
wherein the management server is configured to:
calculate the total value of the used resource amounts of the plurality of the pieces of sub processing as a candidate resource amount, in a case where the management server calculates the required resource amount; and
add a predetermined additional resource amount to the candidate resource amount to calculate the required resource amount, in a case where the obtaining period is less than a predetermined threshold.

4. The computer system according to claim 2, wherein the management server is configured to select a candidate physical computer which is large in number of the virtual computers operating on the candidate physical computer, and is small in the resource amount of the free resource on the candidate physical computer, in a case where there are a plurality of the candidate physical computers.

5. The computer system according to claim 1, wherein the virtual computer is configured to:
obtain one of an execution priority and a lifetime for the each of the plurality of the pieces of sub processing;
select one of sub processing having the obtained execution priority equal to or more than a predetermined threshold and sub processing having the obtained lifetime equal to or more than a predetermined threshold as subject sub processing; and
obtain a used resource amount for each of a plurality of pieces of the subject sub processing.

6. The computer system according to claim 1,
wherein the obtaining command includes identification information on the plurality of the pieces of sub processing from which the used resource amount is to be obtained, and
wherein the virtual computer is configured to:
select a plurality of pieces of subject sub processing from which the used resource amount is to be obtained out of the plurality of the pieces of sub processing based on the identification information on the plurality of the pieces of sub processing included in the received obtaining command; and
obtain the used resource amount for each of the plurality of pieces of subject sub processing.

7. A migration method for a computer system including: a plurality of physical computers; and a management server for managing the plurality of physical computers,
wherein at least one virtual computer operate on each of the plurality of physical computers, which is assigned an assigned resource generated by dividing a computer resource included in the physical computer into a plurality of parts,
wherein the at least one virtual computer executes at least one piece of service processing including at least one piece of sub processing,
wherein the each of the plurality of physical computers includes: a first processor; a first main storage medium coupled to the first processor; a sub storage medium coupled to the first processor; a first network interface coupled to the first processor; a virtual management module for managing the at least one virtual computer; and a used resource amount obtaining module for obtaining a used resource amount which is information on a used amount of the assigned resource used by executing the at least one piece of service processing,
wherein the management server includes: a second processor; a second storage medium coupled to the second processor; a second network interface coupled to the second processor; a resource information management module for managing resource information including information on the computer resource included in the each of the plurality of physical computers; an assigned resource information management module for managing assigned resource information including information on the assigned resource; an obtaining command module for transmitting a command to obtain the used resource amount to the virtual management module; and a migration processing module for executing migration processing for a virtual computer,
wherein the migration method includes:
a first step of transmitting, by the management server, the obtaining command to each of the virtual computers;
a second step of obtaining, by the each of the virtual computers the used resource amount for each of the pieces of sub processing based on the obtaining command transmitted from the management server;
a third step of transmitting, by the each of the virtual computers, the obtained used resource amount for the each of the pieces of sub processing to the management server;
a fourth step of obtaining, by the management server, the resource information and the assigned resource information from the each of the plurality of physical computers;
a fifth step of generating, by the management server, free resource information which is information on a free resource representing an unused computer resource in the computer system based on the obtained resource information and the obtained assigned resource information, in a case where the management server receives a request to execute the migration processing of the virtual computer;
a sixth step of calculating, by the management server, a required resource amount which is a resource amount of a computer resource required for the virtual computer subject to the migration based on the obtained used resource amount for the each of the pieces of sub processing;
a seventh step of searching for, by the management server, a physical computer of a migration destination based on the generated free resource information and the calculated required resource amount; and
an eighth step of migrating, by the management server, the virtual computer subject to the migration to the physical computer of the migration destination based on a result of the search.

8. The migration method according to claim 7,
wherein the seventh step includes calculating a total value of the used resource amounts of the pieces of sub processing as the required resource amount, and
wherein the eighth step includes:
referring to the free resource information to select the free resource;
determining whether a resource amount of the selected free resource is equal to or more than the required resource amount; and
selecting the physical computer corresponding to the selected free resource as a candidate physical computer serving as the migration destination of the virtual computer subject to the migration, in a case where the resource amount of the selected free resource is equal to or more than the required resource amount.

9. The migration method according to claim 8,
wherein the obtained used resource amount for the each of the pieces of sub processing includes an obtaining period representing a period in which the used resource amount has been obtained, and
wherein the seventh step includes:
calculating a total value of the used resource amounts of the pieces of sub processing as a candidate resource amount; and
adding a predetermined additional resource amount to the candidate resource amount, thereby calculating the required resource amount, in a case where the obtaining period is less than a predetermined threshold.

10. The migration method according to claim 8, wherein the eighth step includes selecting a candidate physical computer which is large in number of the virtual computers operating on the candidate physical computer, and is small in the resource amount of the free resource on the candidate physical computer, in a case there are a plurality of the candidate physical computers.

11. The migration method according to claim 7, wherein the second step includes:
obtaining one of an execution priority and a lifetime of the sub processing;
selecting one of sub processing having the obtained execution priority equal to or more than a predetermined threshold and sub processing having the obtained lifetime equal to or more than a predetermined threshold as subject sub processing; and
obtaining a used resource amount for each of pieces of the subject sub processing.

12. The migration method according to claim 7,
wherein the obtaining command includes identification information on the sub processing subject from which the used resource amount is to be obtained, and
wherein the second step includes:
selecting subject sub processing from which the used resource amount is to be obtained out of the pieces of sub processing based on the identification information on the sub processing included in the received obtaining command; and
obtaining the used resource amount for each of pieces of the subject sub processing.

13. A management server for managing a plurality of physical computers each including a first processor, a first storage medium coupled to the first processor, and a first network interface coupled to the first processor,
wherein at least one virtual computer operates on each of the plurality of physical computers, which is assigned an assigned resource generated by dividing a computer resource included in the each of the plurality of physical computers into a plurality of parts,
wherein the at least one virtual computer executes at least one piece of service processing including at least one piece of sub processing,
wherein the management server comprises:
a second processor;
a second storage medium coupled to the second processor;
a second network interface coupled to the second processor;
a resource information management module for managing resource information including information on the computer resource included in the each of the plurality of physical computers;
an assigned resource information management module for managing assigned resource information including information on the assigned resource;
an obtaining command module for transmitting a command to obtain a used resource amount representing a used amount of the assigned resource used by executing the at least one piece of service processing to the virtual management module; and
a migration processing module for executing migration processing for the virtual computer,
the management server being configured to:
obtain, by transmitting the obtaining command to each of the virtual computers, the used resource amount for each of the pieces of sub processing;
obtain the resource information and the assigned resource information from the each of the plurality of physical computers;
generate free resource information which is information on a free resource representing an unused computer resource in the each of the plurality of physical computers based on the obtained resource information and the obtained assigned resource information, in a case where the management server receives a request to execute the migration processing of the virtual computer;
calculate a required resource amount which is a resource amount of a computer resource required for the virtual computer subject to the migration, based on the obtained used resource amount for the each of the pieces of sub processing;
search for a physical computer of a migration destination based on the generated free resource information and the calculated required resource amount; and
migrate the virtual computer subject to the migration to the physical computer of the migration destination based on a result of the search.

14. The management server according to claim 13, being configured to:
calculate a total value of the used resource amounts of the pieces of sub processing as the required resource amount;
refer to the free resource information to select the free resource;
determine whether a resource amount of the selected free resource is equal to or more than the required resource amount; and
select the physical computer corresponding to the selected free resource as a candidate physical computer serving as the migration destination of the virtual computer subject to the migration, in a case where the resource amount of the selected free resource is equal to or more than the required resource amount.

15. The management server according to claim 14,
wherein the obtained used resource amount for the each of the pieces of sub processing includes an obtaining period representing a period in which the used resource amount has been obtained, and
wherein the management server is configured to:
calculate the total value of the used resource amounts of the pieces of sub processing as a candidate resource amount, in a case where the management server calculates the required resource amount; and
add a predetermined additional resource amount to the candidate resource amount to calculate the required resource amount, in a case where the obtaining period is less than a predetermined threshold.

16. The management server according to claim 14, being configured to select a candidate physical computer which is large in number of the virtual computers operating on the candidate physical computer, and is small in the resource amount of the free resource on the candidate physical computer, in a case where there are a plurality of the candidate physical computers.
